(19) United States
(12) Patent Application Publication
(10) Pub. No.: US 2026/0013560 A1
(43) Pub. Date: Jan. 15, 2026

(54) HEATER ASSEMBLY WITH IMPROVED WICKING MATERIAL CONTACT FOR AN AEROSOL-GENERATING DEVICE

(71) Applicant: Philip Morris Products S.A., Neuchatel (CH)

(72) Inventor: Enrico TURRINI, Neuchâtel (CH)

(73) Assignee: Philip Morris Products S.A., Neuchatel (CH)

(21) Appl. No.: 18/993,361

(22) PCT Filed: Jul. 28, 2023
(86) PCT No.: PCT/EP2023/071010

§ 371 Date: Jan. 10, 2025

(30) Foreign Application Priority Data
Aug. 5, 2022 (EP) 22189091.6

(51) Int. Cl. A24F 40/46; A24F 40/10; A24F 40/42; A24F 40/44; A24F 40/57; H05B 3/22

(52) U.S. Cl. CPC A24F 40/46; A24F 40/10; A24F 40/42; A24F 40/44; A24F 40/57; H05B 3/22

(57) ABSTRACT

A heater assembly for an aerosol-generating device is provided, the assembly including: a frame including an aperture in a first plane; a heating element fixed to the frame; and first and second electrical contacts in electrical contact, respectively, with first and second ends of the element; the element providing a continuous electrical path between the first and the second contacts, the element including heating portions and an attachment portion positioned between heating portions along the path, each heating portion within or overlying the aperture and separated from the frame by the attachment portion, each heating portion including a radius of curvature orthogonal to the first plane, the frame including an upper surface parallel to the first plane, and a first part of the element being recessed from the upper surface by a first distance, and a second part of the element coinciding with a plane formed by the upper surface.

The present disclosure relates to a heater assembly for an aerosol-generating device or a cartridge; an aerosol-generating device comprising a heater assembly; an aerosol-generating system comprising a cartridge and an aerosol-generating device; and a cartridge comprising a heater assembly.

Aerosol-generating systems configured to generate inhalable aerosol from an aerosol-forming substrate are known in the art. Some prior aerosol-generating systems comprise an aerosol-generating-device that is couplable to a cartridge. A typical cartridge for use with an aerosol-generating device comprises an aerosol-forming substrate and a heater assembly, where the heater assembly comprises a heating element. Often, the aerosol-forming substrate is a liquid. In this case, the cartridge may further comprise a wicking material in fluidic communication with the aerosol-forming substrate and in contact with the heating element. The wicking material is configured to transport liquid aerosol-forming substrate to the heating element. In use, the heating element is configured to vaporise the liquid aerosol-forming substrate. For example, the heating element may be restively heated. An airflow is provided past the heating element to entrain the generated vapour. In the airflow the vapour is condensed and an aerosol is formed. The aerosol may then be inhaled by a user. The aerosol-generating device typically comprises a power supply that is configured to supply power to the heating element when the device and cartridge are coupled together, via electrical connectors.

In aerosol-generating systems of this type, the heating element is secured to other components of the heater assembly, aerosol-generating device, cartridge, or aerosol-generating system, depending on the location of the heating element. This provides stability to the heating element, and can minimise damage to the heating element during use. However, as the heating element is at an elevated temperature during use, heat may be transferred from the heating element to other components of the heater assembly, aerosol-generating device, cartridge, or aerosol-generating system. This heat transfer may damage these other components. Additionally, this heat transfer may cause other components of the aerosol-generating device, cartridge, or aerosol-generating system to become hot to the touch during use, which would be detrimental to the overall experience of the user.

It would therefore be desirable to provide a heater assembly, an aerosol-generating device, a cartridge, and an aerosol-generating system, which during use minimises heat transfer between the heating element and other components of the heater assembly, aerosol-generating device, cartridge, or aerosol-generating system.

Additionally, in aerosol-generating systems of this type, the heating element is typically coupled to a wicking material to transport liquid aerosol-forming substrate to the heating element. Reliable physical contact between the heating element and the wicking material is beneficial for reliable aerosol generation.

According to a first embodiment of the present disclosure, there is provided a heater assembly for an aerosol-generating device. The heater assembly may comprise a heating element, a first electrical contact in electrical contact with a first end of the heating element, and a second electrical contact in electrical contact with a second end of the heating element. The heating element may provide a continuous electrical path between the first electrical contact and the second electrical contact. The heating element may comprise a plurality of heating portions. The heating element may further comprise at least one attachment portion. The at least one attachment portion may be positioned between heating portions along the continuous electrical path. The heating element may comprise a frame comprising an aperture in a first plane, wherein the heating element is fixed to the frame and. Each heating portion may be within or overlie the aperture. Each heating portion may be separated from the frame by at least one attachment portion. At least one heating portion may comprise a radius of curvature orthogonal to the first plane. At least one heating portion may comprise a finite radius of curvature orthogonal to the first plane. Each heating portion may comprise a radius of curvature orthogonal to the first plane. At least one heating portion may extend in a convex manner with respect to the direction from which a wicking element may be coupled to the heater assembly. At least one heating portion may comprise at least two sections which extend in at least two different directions not parallel to the first plane. At least one heating portion may extend in an arch out of the first plane. At least one heating portion may extend in a dome out of the first plane. At least one heating portion may curve out of the first plane. At least one heating portion may extend in an arcuate manner out of the first plane. At least one heating portion may comprise a radius of curvature orthogonal to the first plane such that when the at least one heating portion is reversibly deformed by a force such that the at least one heating portion lies parallel to the first plane, the reaction force exerted by the at least one heating portion is greater at the centre of the at least one heating portion than the reaction force exerted at a periphery of the at least one heating portion. Advantageously, when the aerosol-generating device is coupled to a cartridge such that the heater assembly is coupled to a wicking element, the heating element may provide reliable physical contact with a surface of the wicking element. Moreover, when the aerosol-generating device is coupled to a cartridge such that the heater assembly is coupled to a wicking element, the heating element may exert a greater force at the centre of a connecting surface of the wicking element than at a periphery of the connecting surface of the wicking element. In some embodiments, for example those where the heating element comprises further bends out of the first plane, a radius of curvature orthogonal to the first plane may ensure that the pressure exerted on the connecting surface of the wicking element by the heating element is even across the connecting surface, which may be beneficial.

Each heating portion may comprise an identical radius of curvature orthogonal to the first plane. Alternatively, each heating portion may comprise a radius of curvature orthogonal to the first plane selected from a plurality of radii of curvature. For example, each heating portion may comprise a different radius of curvature orthogonal to the first plane.

The heater assembly may be configured such that when a wicking element is coupled to the heater assembly, the heating element exerts a force unevenly on a connecting surface of the wicking element. For example, the heating element may exert a greater force at the centre of the connecting surface of the wicking element than at the periphery of the connecting surface of the wicking element.

The heating element may comprise a resilient material. Advantageously, when the aerosol-generating device is coupled to a cartridge such that the heater assembly is coupled to a wicking element, the heating element may therefore undergo elastic deformation instead of fracturing.

The cross sectional area of each heating portion perpendicular to the direction of the continuous electrical path may less than the cross sectional area of each attachment portion perpendicular to the direction of the continuous electrical path. Advantageously, heat transfer from the heating element to the frame is therefore reduced. Therefore, the frame may experience a lower temperature during use.

The plurality of heating portions and the at least one attachment portion may be all integrally formed. Advantageously, this may simplify manufacturing and increase the robustness of the heating element.

Each attachment portion may be directly connected to exactly two heating portions. Each heating portion may be directly connected to exactly two attachment portions, or exactly one attachment portion and either the first electrical contact or the second electrical contact. Such an arrangement may advantageously provide an electrical pathway that is easy to manufacture to ensure that the cross sectional area of each heating portion perpendicular to the direction of the continuous electrical path may less than the cross sectional area of each attachment portion perpendicular to the direction of the continuous electrical path.

Each heating portion may have a first width in a first direction, and each attachment portion may have a second width in the first direction, and the second width may be greater than the first width. Advantageously, this provides an arrangement which ensures that the cross sectional area of each heating portion perpendicular to the direction of the continuous electrical path may less than the cross sectional area of each attachment portion perpendicular to the direction of the continuous electrical path, and is straightforward to manufacture by common manufacturing methods such as laser cutting, waterjet cutting or chemical etching stamping.

Each heating portion may extend perpendicular to the first direction. The first direction may lie in the first plane. The first direction may be perpendicular to the direction of the continuous electrical path when the direction of the continuous electrical path is defined by each heating portion. The ratio of the first width to the second width may be between 1/20 and 1/2. Preferably, the ratio of the first width to the second width is between 1/10 and 1/4. The first width may be between 0.1 millimetres and 2 millimetres. Preferably, the first width is between 0.2 millimetres and 1 millimetre. More preferably, the first width is between 0.2 millimetres and 0.5 millimetres.

The heating element may have a thickness in at least one direction perpendicular to the first direction. The thickness may be between 0.02 millimetres and 0.5 millimetres. Preferably, the thickness is between 0.05 millimetres and 0.3 millimetres. Such dimensions may advantageously provide a heating element which is robust and can provide sufficient energy to heat an aerosol-forming substrate when the aerosol-generating device is a handheld device.

The heater assembly may comprise gaps between adjacent heating portions. The gaps may have a gap width. The gap width may be in the first direction. The gap width may be between 0.1 millimetres and 1 millimetre. Preferably, the gap width is between 0.2 millimetres and 0.5 millimetres.

The plurality of heating portions may comprise between 2 heating portions and 20 heating portions. Preferably, the plurality of heating portions comprises between 3 heating portions and 9 heating portions. Preferably still, the plurality of heating portions comprises 6 heating portions. Preferably, the plurality of heating portions comprises an even number of heating portions. Advantageously, an even number of heating portions means the first and second electrical contacts may be positioned on the same side of the heater assembly.

The electrical resistance per unit length in the direction of the electrically conductive path of the plurality of heating portions may be greater than the electrical resistance per unit length in the direction of the electrically conductive path of the at least one attachment portions. The electrical resistance per unit length may be measured by measuring the electrical resistance over each of the heating portions or attachment portions, and dividing the electrical resistance by the length of each of the heating portions or attachment portions in the direction of the electrically conductive path. The direction of the electrically conductive path may be a curve, for example, if the attachment portion is curved. The electrical resistance of each heating portion may be higher than the electrical resistance of each attachment portion.

The heater assembly may be configured such that when a non-zero voltage is applied across the heating element between the first and second electrical contacts, the temperatures of the plurality of heating portions increase more than the temperatures of the at least one attachment portions. The heater assembly may be configured such that when a non-zero current is applied through the heating element between the first and second electrical contacts, the temperatures of the plurality of heating portions increase more than the temperatures of the at least one attachment portions. In these cases, the temperatures of the plurality of heating portions and the temperatures of the at least one attachment portions may be average temperatures over the lengths of each of the plurality of heating portions the at least one attachment portions.

The heating element may be serpentine in shape. The heating element may be serpentine in shape in the first plane. The heating element may be serpentine in shape when projected onto the first plane. Advantageously, such arrangements allows for many heating portions to be positioned or packed within a reduced area. Additionally, the serpentine arrangement may be fluid permeable. The heater assembly may comprise spaces between heating portions of the heating element. Therefore the vapour generated by the heating element may pass through the serpentine heating element.

The heating element may comprise stainless steel. The heating element may comprise a ferrimagnetic or ferromagnetic material. Advantageously, the skin depth in a ferrimagnetic or a ferromagnetic material decreases when increasing the frequency of an alternating current applied to the heating element. The electrical resistance of the heating element increases as function of frequency. The use of ferrimagnetic or a ferromagnetic track may therefore allow for an in increase to its electrical resistance. This locally generates more heat, without reducing the thickness and compromising the mechanical strength of the heating element.

The heating element may be coated with a corrosion resistant material. In particular, the heating element may be coated with a ceramic material. Advantageously, this may increase the lifespan of the heating element, and the heater assembly. This is particularly relevant, as the heater assembly may be configured to be reversibly coupled with and decoupled from a wicking element, so the heater assembly may be configured to be reusable.

The heating element may be substantially flat. Advantageously, this may simplify manufacturing of the heating element.

The total resistance of the heating element may be between 0.1 Ohms and 5 Ohms. Preferably, the total resistance of the heating element is between 0.2 Ohms and 1.5 Ohms.

The heating element and the first and second electrical contacts may be integrally formed. The heating element and the first and second electrical contacts may be formed of the same material. Advantageously, these features may simplify manufacturing of the heating element.

The aperture may be substantially square or rectangular. Alternatively, the aperture may be substantially circular. Advantageously, such shapes for the aperture may ensure that a wicking element is easily aligned with the aperture when the aerosol-generating device is coupled to a cartridge. Additionally, such shapes may be simple to manufacture for the aperture or corresponding wicking element.

The frame may be electrically insulating. In particular, the frame may have a thermal conductivity of 1 W/mK or less. This may advantageously ensure that the electrical pathway through the heating element is well defined as a single electrical pathway, and minimise current flow through the frame, and hence resistive heating of the frame.

The frame may comprise a heat-resistant polymer. For example, the frame may comprise polyether ether ketone (PEEK). Alternatively, the frame may comprise a ceramic. For example, the frame may comprise alumina. In another example, the frame may comprise zirconia.

The frame may be overmoulded over a section of the heating element. For example, the frame may be overmoulded over an attachment section of the at least one attachment portions. Additionally or alternatively, the frame may be overmoulded over at least an attachment section of the first electrical contact and at least a section of the second electrical contact. Advantageously, overmoulding may provide a robust connection between the frame and the heating element.

The frame may comprise an upper element and a lower element. The upper element and the lower element may comprise press fit elements such that the upper element and the lower elements may be coupled together by press fitting. Alternatively, the upper element and the lower element may comprise snap fit elements such that the upper element and lower element may be coupled together by snap fitting. Alternatively, the upper element and the lower element may comprise fastening elements such that the upper element and lower element may be coupled together by fastening. Advantageously, the frame comprising an upper element and a lower element may provide for simplified manufacturing and a modular system wherein the heating element may be replaced, for example. At least an attachment section of the at least one attachment portions may be located between the upper element and the lower element when the upper element and lower element are coupled together. Additionally or alternatively, at least an attachment section of the first electrical contact and at least a section of the second electrical contact may be located between the upper element and the lower element when the upper element and lower element are coupled together. Advantageously, such arrangements ensure that the heating portions are not in contact with the frame.

The aperture may have a cross sectional area between 1 millimetre squared and 1000 millimetres squared in the first plane. Preferably, the aperture has a cross sectional area between 2 millimetres squared and 200 millimetres squared in the first plane. More preferably, the aperture has a cross sectional area between 4 millimetres squared and 50 millimetres squared in the first plane.

The heating element may further comprise at least one heat isolating portion. Each attachment portion may be separated from the frame by one heat isolating portion. Advantageously, heat isolating portions may further reduce the amount of heat transferred to the frame from the plurality of heating portions via the at least one attachment portions.

Each heating portion may be connected to the frame via at least one heat isolating portion.

The plurality of heating portions, the at least one attachment portions, and the at least one heat isolating portion may be all integrally formed. Advantageously, this simplifies manufacturing, as the heating element may be produced by common manufacturing methods such as laser cutting, waterjet cutting or chemical etching stamping.

Each heat isolating portion may be not directly attached to any heating portions. There may be an attachment portion intermediate each heat isolating portion and any heating portion. Each heat isolating portion may lie outside of the continuous electrical path. For example, each heat isolating portion may lie outside of the continuous electrical path such that the heat isolating portions undergo a lower increase in temperature due to direct resistive heating than both the increase in temperature of each attachment portion and the increase in temperature of each heating portion.

Each heat isolating portion may have a third width in the first direction. The third width may be smaller than the second width. The ratio of the third width to the second width may be between 1/10 and 2/3. Preferably, the ratio of the third width to the second width is between 1/5 and 1/3.

The third width may be approximately equal to the first width. Advantageously, this provides a heat isolating portion which reduces the amount of heat transferred from the heating portions to the frame, whilst simplifying manufacturing.

The thermal resistance over each attachment portion between adjacent heating portions and adjacent heat isolating portions may be lower than the thermal resistance over each heat isolating portion between adjacent attachment portions and the frame. Thermal resistance may be defined a temperature difference by which an object or material resists a heat flow. The thermal resistance (R) over an attachment portion between adjacent heating portions and adjacent heat isolating portions may be defined as:

$$R = \frac{x}{A \cdot k}$$

wherein x is the length of each attachment portion measured between adjacent heating portions and adjacent heat isolating portions in the direction of a thermal pathway, A is the cross sectional area of each attachment portion in the direction of the thermal pathway between adjacent heating portions and adjacent heat isolating portions, and k is the thermal conductivity of each attachment portion, which is a material constant.

The thermal resistance over each heat isolating portion between adjacent attachment portions and the frame may be defined using an identical equation, wherein x is the length of each heat isolating portion measured between adjacent attachment portions and the frame in the direction of a thermal pathway, A is the cross sectional area of each heat isolating portion in the direction of the thermal pathway between adjacent attachment portions and the frame, and k is the thermal conductivity of each heat isolating portion, which is a material constant.

The frame may comprise an upper surface parallel to the first plane. At least a first part of the heating element may recessed from the upper surface of the frame by a first distance. The first distance may be between 0.2 mm and 5 mm. Advantageously, such an arrangement may protect at least the first part of the heating element from damage, particularly if the heating element is uncovered and on an outer surface of an aerosol-generating device. An attachment section of the at least one attachment portions may be recessed from the upper surface of the frame by the first distance.

At least a second part of the heating element may coincide with a plane formed by the upper surface of the frame. Advantageously, such an arrangement means that the protrusion required of a wicking element is minimised, wherein the wicking element is configured to contact the heating element when a cartridge comprising a wicking element is coupled to an aerosol-generating device comprising the heater assembly. At least a second part of the heating element may coincide with a plane formed by the upper surface of the frame. At least a second part of the heating element may extend beyond the plane formed by the upper surface of the frame. The radius of curvature orthogonal to the first plane may be applied to the second part of the heating element.

Alternatively, the entire heating element may be recessed from the upper surface of the frame by the first distance. Advantageously, and as stated above, such an arrangement may protect the entire heating element from damage, particularly if the heating element is uncovered and on an outer surface of an aerosol-generating device.

The frame may comprise a lower surface parallel to the first plane. At least the first part of the heating element may be recessed from the lower surface of the frame by a second distance. The second distance may be between 0.2 mm and 5 mm.

An attachment section of the at least one attachment portions may be recessed from the lower surface of the frame by the second distance. Advantageously, such an arrangement may protect at least the at least one attachment portion from damage, particularly during handling of the heater assembly and assembly of an aerosol-generating device.

The heater assembly may further comprise a support structure. The frame may at least partially surround the support structure. The support structure may comprise a support structure aperture. The support structure aperture may lie in the first plane. The support structure aperture may be substantially circular. The support structure aperture may be substantially square or rectangular. The support structure aperture may be substantially oval in shape. The support structure may comprise a heat-resistant polymer. For example, the support structure may comprise polyether ether ketone (PEEK). Alternatively, the support structure may comprise a ceramic. For example, the support structure may comprise alumina. In another example, the support structure may comprise zirconia. The support structure may comprise the same material as the frame. Alternatively, the support structure may comprise a different material to the frame. The support structure aperture may have a cross sectional area between 1 millimetre squared and 1000 millimetres squared in the first plane. The support structure aperture may have a cross sectional area between 2 millimetres squared and 200 millimetres squared in the first plane Preferably, the support structure aperture has a cross sectional area between 4 millimetres squared and 50 millimetres squared in the first plane.

At least a portion of the heating element may be within the support structure aperture. In particular, the plurality of heating portions may be within the support structure aperture. At least a portion of the heating element may overlie the support structure aperture. In particular, the plurality of heating portions may overlie the support structure aperture. Advantageously, such features allow for aerosol to be easily transported from the heating element, where aerosol is generated, to a user.

The support structure may comprise an upper support structure surface parallel to the first plane. At least a part of the heating element may be co-planar with the upper support structure surface. The plurality of heating portions may be substantially co-planar with the upper support structure surface. Advantageously, such an arrangement means that the protrusion required of a wicking element is minimised, wherein the wicking element is configured to contact the heating element when a cartridge comprising a wicking element is coupled to an aerosol-generating device comprising the heater assembly.

Each attachment portion may comprise a first section and a second section. Each first section may be substantially coplanar with the upper support structure surface. Each second section may extend from the upper support structure surface towards a second plane. The second plane may be parallel but not co-planar with the upper support structure surface. Each second section may extend in a direction perpendicular to the upper support structure surface. Advantageously, this arrangement may provide a more robust structure for the heating element.

Each second section may be positioned between the frame and the support structure. Each second section may be secured between the frame and the support structure. Advantageously, each second section being positioned or secured between the frame and the support structure may result in a heating element which is firmly secured in place.

Both of the first and second electrical contacts may comprise a first electrical contact section and a second electrical contact section. Both first electrical contact sections may be substantially coplanar with the upper support structure surface. Both second electrical contact sections may extend from the upper support structure surface towards the second plane. Both second electrical contact sections may extend in a direction perpendicular to the upper support structure surface. Advantageously, this arrangement may provide a more robust structure for the heating element.

Both second electrical contact sections may be positioned between the frame and the support structure. Both second electrical contact sections may be secured between the frame and the support structure. Advantageously, both second electrical contact sections being positioned or secured between the frame and the support structure may result in a heating element which is firmly secured in place.

The frame may comprise an upper surface co-planar with the upper support structure surface. The frame may comprise a lower frame surface. The support structure may comprise a lower support structure surface co-planar with the lower surface of the frame. Each of the first and second electrical contacts may further comprise a third electrical contact section. Both third electrical contact sections may be substantially co-planar with the lower surface of the frame.

The plurality of heating portions may be co-planar with the upper surface of the frame.

According to a second embodiment of the present disclosure, there is provided an aerosol-generating device. The aerosol-generating device may comprise a heater assembly. The aerosol-generating device may comprise a heater assembly according to the first embodiment of the present disclosure. The heater assembly may comprise a heating element. The heater assembly may comprise a first electrical contact in electrical contact with a first end of the heating element. The heater assembly may comprise a second electrical contact in electrical contact with a second end of the heating element. The heating element may provide a continuous electrical path between the first electrical contact and the second electrical contact. The heating element may comprise a plurality of heating portions. The heating element may comprise at least one attachment portion positioned between heating portions along the continuous electrical path. The heater assembly may comprise a frame. The frame may comprise an aperture in a first plane. The heating element may be fixed to the frame. Each heating portion may be within the aperture. Each heating portion may overlie the aperture. Each heating portion may be separated from the frame by at least one attachment portion. At least one heating portion may comprise a radius of curvature orthogonal to the first plane. The cross sectional area of each heating portion perpendicular to the direction of the continuous electrical path may be less than the cross sectional area of each attachment portion perpendicular to the direction of the continuous electrical path.

The aerosol-generating device may further comprise an air flow passage defined between an air inlet and an air outlet. The airflow passage may be in fluid communication with the heating element. In particular, the airflow passage may be in fluid communication with a first side of the heating element. The airflow passage may pass through the heater assembly. The heater assembly may comprise a heater assembly airflow passage between a heater assembly air inlet and a heater assembly air outlet. The aerosol-generating device may further comprise a power supply. The power supply may be in electrical contact with the first and second electrical contacts. The power supply may be configured to supply power to the heating element. The aerosol-generating device may further comprise control circuitry. The control circuitry may be configured to control the supply of power from the power supply to the heating element.

The battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

The control circuitry may be connected to the power source. The control circuitry may be connected to the heating element. The control circuitry may control the supply of power from the power source to the heating element. The control circuitry may control a temperature of the heating element. The control circuitry may comprise a controller. The control circuitry may comprise a microcontroller. The microcontroller may be a programmable microcontroller.

The aerosol-generating device may be a handheld aerosol-generating device. The aerosol-generating device may have a size comparable to a conventional cigar or cigarette. The aerosol-generating device may have a total length between about 25 mm and about 150 mm. The aerosol-generating device may have an external diameter between about 5 mm and about 30 mm.

The control circuitry may further comprise a puff detector in fluid communication with the airflow passage. The device may be configured such that the heating element is puff actuated. Advantageously, this may reduce energy consumption from the battery, and ensure that aerosol is only generated when desired by the user.

The air inlet may be defined in a side wall of the device. The air outlet may be defined in an end wall of the device. The air outlet may be defined in a proximal end wall of the device. Advantageously, the air outlet being defined in a proximal end wall of the device means that a cartridge comprising a mouthpiece may be easily coupled to the proximal end wall, and so easily couple to the air outlet. The side wall of the device may extend perpendicular to the end wall of the device.

According to a third embodiment of the present disclosure, there is provided an aerosol-generating system. The aerosol-generating system may comprise a cartridge. The cartridge may comprise an aerosol-forming substrate. The cartridge may comprise a reservoir containing the aerosol-forming substrate. The aerosol-forming substrate may be in fluid communication with a wicking material. The wicking material may form part of an external surface of the cartridge.

The aerosol-generating system may comprise an aerosol-generating device. The aerosol-generating system may comprise an aerosol-generating device according to the second embodiment of the present disclosure. The aerosol-generating device may comprise a heater assembly. The aerosol-generating device may comprise a heater assembly according to the first embodiment of the present disclosure. The heater assembly may comprise a heating element. The heater assembly may further comprise a first electrical contact in electrical contact with a first end of the heating element. The heater assembly may further comprise a second electrical contact in electrical contact with a second end of the heating element. The heating element may provide a continuous electrical path between the first electrical contact and the second electrical contact.

The heating element may comprise a plurality of heating portions. The heating element may further comprise at least one attachment portion. The at least one attachment portion may be positioned between heating portions along the continuous electrical path.

The heater assembly may comprise a frame. The frame may comprise an aperture. The frame may comprise an aperture in a first plane.

The heating element may be fixed to the frame. Each heating portion may be within the aperture. Each heating portion may overlie the aperture. Each heating portion may be separated from the frame by at least one attachment portion. At least one heating portion may comprise a radius of curvature orthogonal to the first plane.

The cross sectional area of each heating portion perpendicular to the direction of the continuous electrical path may be less than the cross sectional area of each attachment portion perpendicular to the direction of the continuous electrical path.

The aerosol-generating system may comprise a system air flow passage defined between a system air inlet and a system air outlet. In particular, as in the second embodiment, the aerosol-generating device may further comprise an air flow passage defined between an air inlet and an air outlet. The system airflow passage may comprise the airflow passage of the device. The system air inlet may comprise the air inlet of the device. The system air outlet may comprise the air outlet of the deice. The airflow passage of the device may be in fluid communication with the heating element. In particular, the airflow passage of the device may be in fluid communication with a first side of the heating element. The system airflow passage may pass through the heater assembly. In particular, the airflow passage of the device may pass through the heater assembly. The heater assembly may comprise a heater assembly airflow passage between a heater assembly air inlet and a heater assembly air outlet. The air inlet of the device may comprise the heater assembly air inlet. The system airflow passage may comprise the heater assembly airflow passage. In particular, the airflow passage of the device may comprise the heater assembly airflow passage.

The aerosol-generating device may further comprise a power supply. The power supply may be in electrical contact with the first and second electrical contacts. The power supply may be configured to supply power to the heating element. The aerosol-generating device may further comprise control circuitry. The control circuitry may be configured to control the supply of power from the power supply to the heating element. Advantageously, the power supplied to the heating element may therefore be varied based on usage behaviours.

The cartridge may be reversibly couplable to the aerosol-generating device. The cartridge may be reversibly couplable to the aerosol-generating device such that when the cartridge is coupled to the device the wicking material is in direct contact with the heating element. Advantageously, the cartridge being reversibly couplable to the aerosol-generating device means that the cartridge may be disposed of once empty or damaged, and replaced by a new cartridge. This may save on costs and have an environmental benefit, as fewer components are being disposed of. The wicking element may have a cross sectional area equal to the cross sectional area of the aperture. The wicking element may have a cross sectional shape approximately identical to the cross sectional shape of the aperture.

The airflow passage of the aerosol-generating device may be in fluid communication with a first side of the heating element. When the cartridge is coupled to the device the wicking material may be in direct contact with a second side of the heating element. The first side of the heating element may be opposite to the second side of the heating element.

The cartridge may further comprise a cartridge air flow passage defined between an cartridge air inlet and a cartridge air outlet.

The cartridge may further comprise a removable seal covering a portion of the cartridge. In particular, the cartridge may further comprise a removable seal covering the wicking element. The removable seal may be configured to be removed by a user.

When the cartridge is coupled to the device, the cartridge air inlet may be in fluid communication with the air outlet of the device.

The cartridge air outlet may comprise a mouthpiece.

The aerosol-generating system may be a handheld aerosol-generating system configured to allow a user to suck on a mouthpiece to draw an aerosol through the cartridge air outlet. The aerosol-generating system may have a size comparable to a conventional cigar or cigarette. The aerosol-generating system may have a total length between about 25 mm and about 150 mm. The aerosol-generating system may have an external diameter between about 5 mm and about 30 mm.

The aerosol-forming substrate may be a liquid. In particular, the aerosol-forming substrate may be a liquid at standard temperature and pressure. Advantageously, this ensures that liquid aerosol-forming substrate may be easily transported from the reservoir to the wicking element, and then to the heating element when the system is used at standard temperature and pressure. The aerosol-forming substrate may be a liquid at room temperature. The aerosol-forming substrate may be in another condensed form, such as a solid at room temperature, or may be in another condensed form, such as a gel, at room temperature. Volatile compounds may be released by heating the aerosol-forming substrate. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours. The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

According to a fourth embodiment of the present disclosure, there is provided a cartridge for an aerosol-generating system. The cartridge may comprise an aerosol-forming substrate. The cartridge may comprise an aerosol-forming substrate as described in relation to the third embodiment. The aerosol-forming substrate may be in fluid communication with a wicking material.

The cartridge may comprise a heater assembly. The cartridge may comprise a heater assembly according to the first embodiment of the present disclosure. The cartridge may be configured to be coupled to an aerosol-generating device. The heater assembly may be couplable to and decouplable from a cartridge body. The heater assembly may comprise a heating element. The heater assembly may comprise a first electrical contact in electrical contact with a first end of the heating element. The heater assembly may comprise a second electrical contact in electrical contact with a second end of the heating element. The heating element may provide a continuous electrical path between the first electrical contact and the second electrical contact. The heating element may comprise a plurality of heating portions. The heating element may comprise at least one attachment portion positioned between heating portions along the continuous electrical path. The heater assembly may comprise a frame. The frame may comprise an aperture in a first plane. The heating element may be fixed to the frame. Each heating portion may be within the aperture. Each heating portion may overlie the aperture. Each heating portion may be separated from the frame by at least one attachment portion. At least one heating portion may comprise a radius of curvature orthogonal to the first plane. The heater assembly may form part of an external surface of the cartridge. The wicking material may be in contact with the heating element.

The cartridge may further comprise a cartridge air flow passage. The cartridge airflow passage may be defined between an cartridge air inlet and a cartridge air outlet. The cartridge airflow passage may be in fluid communication with the heating element. In particular, the cartridge airflow passage may be in fluid communication with a first side of the heating element. The cartridge airflow passage may pass through the heater assembly. The heater assembly may comprise a heater assembly airflow passage between a heater assembly air inlet and a heater assembly air outlet. The cartridge air inlet may comprise the heater assembly air inlet.

The cartridge may be configured to be coupled to an aerosol-generating device. The cartridge may be configured to be coupled to an aerosol-generating device such that the cartridge air inlet aligns with a device air outlet of the aerosol-generating device.

The cartridge air outlet may comprise a mouthpiece.

The aerosol-forming substrate may be a liquid. In particular, the aerosol-forming substrate may be a liquid at standard temperature and pressure. Advantageously, this ensures that liquid aerosol-forming substrate may be easily transported from the reservoir to the wicking element, and then to the heating element when the system is used at standard temperature and pressure.

As used herein, the term “heating element” refers to an element of a heater assembly, the element being configured to be heated. For example, the term “heating element” may refer to an element configured for at least a portion of the element to be heated to at least 50, 100, 150, 200, 250, or 300 degrees Celsius.

As used herein, the term ‘coupled or couplable’ is used to mean that the cartridge and device can be coupled and uncoupled from one another and without significantly damaging either the device or cartridge.

As used herein, the term ‘serpentine’ is used to define a shape of a pathway which when viewed perpendicular to the plane of the pathway comprises at least one curve or bend of approximately 180 degrees in the pathway, such that a first area of the shape lies alongside a second area of the shape. The shape may therefore resemble a single Latin letter ‘S’, or multiple Latin letter ‘S’ connected end to end.

As used herein, the terms “air inlet’ and ‘air outlet” are used to describe one or more apertures through which air may be drawn into, and out of, respectively, of a component or portion of a component of the heater assembly, aerosol-generating system, cartridge or aerosol-generating device.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, an “aerosol-generating system” means a system that generates an aerosol from one or more aerosol-forming substrates.

As used herein, the term “aerosol-forming substrate” means a substrate capable of releasing volatile compounds that may form an aerosol. Such volatile compounds may be released by heating the aerosol-forming substrate.

The invention is defined in the claims. However, below there is provided a non-exhaustive list of non-limiting examples. Any one or more of the features of these examples may be combined with any one or more features of another example, embodiment, or aspect described herein.

Example Ex1. A heater assembly for an aerosol-generating device, the heater assembly comprising:
a frame comprising an aperture in a first plane,
a heating element fixed to the frame,
a first electrical contact in electrical contact with a first end of the heating element, and
a second electrical contact in electrical contact with a second end of the heating element, the heating element providing a continuous electrical path between the first electrical contact and the second electrical contact,
wherein the heating element comprises a plurality of heating portions and at least one attachment portion positioned between heating portions along the continuous electrical path,
wherein each heating portion is within or overlies the aperture and is separated from the frame by at least one attachment portion, and
wherein each heating portion comprises a radius of curvature orthogonal to the first plane.

Example Ex2. A heater assembly according to Example Ex1, wherein the heating element comprises a resilient material.

Example Ex3. A heater assembly according to Example Ex1 or Ex2, wherein the cross sectional area of each heating portion perpendicular to the direction of the continuous electrical path is less than the cross sectional area of each attachment portion perpendicular to the direction of the continuous electrical path.

Example Ex4. A heater assembly according to any preceding Example, wherein the electrical resistances of the plurality of heating portions are higher than the electrical resistances of the at least one attachment portions.

Example Ex5. A heater assembly according to any preceding Example, wherein the frame comprises an upper surface parallel to the first plane, and at least a first part of the heating element is recessed from the upper surface of the frame by a first distance.

Example Ex6. A heater assembly according to Example Ex5, wherein the first distance is between 0.2 mm and 5 mm.

Example Ex7. A heater assembly according to Example Ex5 or Ex6, wherein an attachment section of each attachment portion is recessed from the upper surface of the frame by the first distance.

Example Ex8. A heater assembly according to any of Examples Ex5 to Ex7, wherein at least a second part of the heating element coincides with a plane formed by the upper surface of the frame.

Example Ex9. A heater assembly according to any of Examples Ex5 to Ex8, wherein the frame comprises a lower surface parallel to the first plane, and at least the first part of the heating element is recessed from the lower surface of the frame by a second distance.

Example Ex10. A heater assembly according to Example Ex9, wherein the second distance is between 0.2 mm and 5 mm.

Example Ex11. A heater assembly according to Example Ex9 or Ex10, wherein an attachment section of the attachment portions is recessed from the lower surface of the frame by the second distance.

Example Ex12. A heater assembly according to any preceding Example, wherein the heating element is serpentine in shape.

Example Ex13. A heater assembly according to any preceding Example, wherein the heater assembly is configured such that when a non-zero voltage is applied across the heating element between the first and second electrical contacts, the temperatures of the plurality of heating portions increase more than the temperatures of the at least one attachment portions.

Example Ex14. A heater assembly according to any preceding Example, wherein the plurality of heating portions and the at least one attachment portion are all integrally formed.

Example Ex15. A heater assembly according to any preceding Example, wherein each attachment portion is directly connected to exactly two heating portions.

Example Ex16. A heater assembly according to any preceding Example, wherein each heating portion is directly connected to exactly two attachment portions, or exactly one attachment portion and either the first electrical contact or the second electrical contact.

Example Ex17. A heater assembly according to any preceding Example, wherein each heating portion has a first width in a first direction, wherein the first direction may be perpendicular to the direction of the continuous electrical path when the direction of the continuous electrical path is defined by each heating portion, and each attachment portion has a second width in the first direction, and wherein the second width is greater than the first width.

Example Ex18. A heater assembly according to Example Ex17, wherein the ratio of the first width to the second width is between 1/20 and 1/2.

Example Ex19. A heater assembly according to Example Ex18, wherein the ratio of the first width to the second width is between 1/10 and 1/4.

Example Ex20. A heater assembly according to Example Ex17, Ex18 or Ex19, wherein the first width is between 0.1 millimetres and 2 millimetres.

Example Ex21. A heater assembly according to Example Ex20, wherein the first width is between 0.2 millimetres and 1 millimetre.

Example Ex22. A heater assembly according to Example Ex21, wherein the first width is between 0.2 millimetres and 0.5 millimetres.

Example Ex23. A heater assembly according to any of Examples Ex17 to Ex22, wherein the heating element has a thickness in at least one direction perpendicular to the first direction.

Example Ex24. A heater assembly according to Example Ex23, wherein the thickness is between 0.02 millimetres and 0.5 millimetres.

Example Ex25. A heater assembly according to Example Ex24, wherein the thickness is between 0.05 millimetres and 0.3 millimetres.

Example Ex26. A heater assembly according to any preceding Example, wherein the electrical resistance per unit length in the direction of the electrically conductive path of the plurality of heating portions is greater than the electrical resistance per unit length in the direction of the electrically conductive path of the at least one attachment portions.

Example Ex27. A heater assembly according to any preceding Example, wherein the heating element comprises stainless steel.

Example Ex28. A heater assembly according to any preceding Example, wherein the heating element comprises a ferrimagnetic or ferromagnetic material.

Example Ex29. A heater assembly according to any of Examples Ex539 to Ex566, wherein the heating element is coated with a corrosion resistant material.

Example Ex30. A heater assembly according to any preceding Example, wherein the heating element is coated with a ceramic material.

Example Ex31. A heater assembly according to any preceding Example, wherein the total resistance of the heating element is between 0.1 Ohms and 5 Ohms.

Example Ex32. A heater assembly according to Example Ex31, wherein the total resistance of the heating element is between 0.2 Ohms and 1.5 Ohms.

Example Ex33. A heater assembly according to any preceding Example, wherein the heating element and the first and second electrical contacts are integrally formed.

Example Ex34. A heater assembly according to any preceding Example, wherein the heating element and the first and second electrical contacts are formed of the same material.

Example Ex35. A heater assembly according to any preceding Example, wherein the aperture is substantially square or rectangular.

Example Ex36. A heater assembly according to any preceding Example, wherein the aperture is substantially circular.

Example Ex37. A heater assembly according to any preceding Example, wherein the frame is electrically insulating.

Example Ex38. A heater assembly according to Example Ex37, wherein the frame has a thermal conductivity of 1 W/mK or less.

Example Ex39. A heater assembly according to Example Ex37 or Ex38, wherein the frame comprises a heat-resistant polymer.

Example Ex40. A heater assembly according to any of Examples Ex37 to Ex39, wherein the frame comprises polyether ether ketone (PEEK).

Example Ex41. A heater assembly according to Example Ex37 or Ex38, wherein the frame comprises a ceramic.

Example Ex42. A heater assembly according to Example Ex41, wherein the frame comprises alumina.

Example Ex43. A heater assembly according to Example Ex41, wherein the frame comprises zirconia.

Example Ex44. A heater assembly according to any preceding Example, wherein the frame is overmoulded over a section of the heating element.

Example Ex45. A heater assembly according to Example Ex44, wherein the frame is overmoulded over an attachment section of the at least one attachment portions.

Example Ex46. A heater assembly according to any preceding Example, wherein the frame is overmoulded over at least an attachment section of the first electrical contact and at least a section of the second electrical contact.

Example Ex47. A heater assembly according to any preceding Example, wherein the frame comprises an upper element and a lower element.

Example Ex48. A heater assembly according to Example Ex47, wherein the upper element and the lower element comprise press fit elements such that the upper element and the lower elements may be coupled together by press fitting.

Example Ex49. A heater assembly according to Example Ex47, wherein the upper element and the lower element comprise snap fit elements such that the upper element and lower element may be coupled together by snap fitting.

Example Ex50. A heater assembly according to Example Ex48 or Ex49, wherein at least an attachment section of the at least one attachment portions is located between the upper element and the lower element when the upper element and lower element are coupled together.

Example Ex51. A heater assembly according to any of Examples Ex48 to Ex50, wherein at least an attachment section of the first electrical contact and at least a section of the second electrical contact is located between the upper element and the lower element when the upper element and lower element are coupled together.

Example Ex52. A heater assembly according to any preceding Example, wherein the aperture has a cross sectional area between 1 millimetre squared and 1000 millimetres squared in the first plane.

Example Ex53. A heater assembly according to Example Ex52, wherein the aperture has a cross sectional area between 2 millimetres squared and 200 millimetres squared in the first plane.

Example Ex54. A heater assembly according to Example Ex53, wherein the aperture has a cross sectional area between 4 millimetres squared and 50 millimetres squared in the first plane.

Example Ex55. A heater assembly according to any preceding Example, wherein the heating element further comprises at least one heat isolating portion, and wherein each attachment portion is separated from the frame by one heat isolating portion.

Example Ex56. A heater assembly according to Example Ex55, wherein each heating portion is connected to the frame via at least one heat isolating portion.

Example Ex57. A heater assembly according to Example Ex55 or Ex56, wherein the plurality of heating portions, the at least one attachment portions, and the at least one heat isolating portion are all integrally formed.

Example Ex58. A heater assembly according to any of Examples Ex55 to Ex57 when dependent on Example Ex17, wherein each heat isolating portion has a third width in the first direction, and wherein the third width is smaller than the second width.

Example Ex59. A heater assembly according to Example Ex58, wherein the ratio of the third width to the second width is between 1/10 and 2/3.

Example Ex60. A heater assembly according to Example Ex59, wherein the ratio of the third width to the second width is between 1/5 and 1/3.

Example Ex61. A heater assembly according any of Examples Ex58 to Ex60, wherein the third width is approximately equal to the first width.

Example Ex62. A heater assembly according to any of Examples Ex55 to Ex61, wherein the thermal resistance over each attachment portion between adjacent heating portions and adjacent heat isolating portions is lower than the thermal resistance over each heat isolating portion between adjacent attachment portions and the frame.

Example Ex63. A heater assembly according to any preceding Example, further comprising a support structure, wherein the frame at least partially surrounds the support structure, and wherein the support structure comprises a support structure aperture.

Example Ex64. A heater assembly according to Example Ex63, wherein at least a portion of the heating element is within or overlies the support structure aperture.

Example Ex65. A heater assembly according to Example Ex64, wherein the plurality of heating portions is within or overlies the support structure aperture.

Example Ex66. An aerosol-generating device comprising a heater assembly, the heater assembly comprising:
a frame comprising an aperture in a first plane,
a heating element fixed to the frame,
a first electrical contact in electrical contact with a first end of the heating element, and
a second electrical contact in electrical contact with a second end of the heating element, the heating element providing a continuous electrical path between the first electrical contact and the second electrical contact,
wherein the heating element comprises a plurality of heating portions and at least one attachment portion positioned between heating portions along the continuous electrical path,
wherein each heating portion is within or overlies the aperture and is separated from the frame by at least one attachment portion, and
wherein each heating portion comprises a radius of curvature orthogonal to the first plane;
an air flow passage defined between an air inlet and an air outlet, the airflow passage in fluid communication with the heating element,
a power supply, the power supply in electrical contact with the first and second electrical contacts and configured to supply power to the heating element, and control circuitry, the control circuitry configured to control the supply of power from the power supply to the heating element.

Example Ex67. An aerosol-generating device according to Example Ex66, wherein the wherein the aerosol-generating device is a handheld aerosol-generating device.

Example Ex68. An aerosol-generating device according to Example Ex66 or Ex67, wherein the control circuitry further comprises a puff detector in fluid communication with the airflow passage, and the device is configured such that the heating element is puff actuated.

Example Ex69. An aerosol-generating device according to any of Examples Ex66 to Ex68, wherein the air inlet is defined in a side wall of the device.

Example Ex70. An aerosol-generating device according to Example Ex69, wherein the air outlet is defined in an end wall of the device.

Example Ex71. An aerosol-generating device according to Example Ex70, wherein the side wall of the device extends perpendicular to the end wall of the device.

Example Ex72. An aerosol-generating device according to any of Examples Ex66 to Ex71, wherein the heating element comprises a resilient material.

Example Ex73. An aerosol-generating device according to any of Examples Ex66 to Ex72, wherein the cross sectional area of each heating portion perpendicular to the direction of the continuous electrical path is less than the cross sectional area of each attachment portion perpendicular to the direction of the continuous electrical path.

Example Ex74. An aerosol-generating device according to any of Examples Ex66 to Ex73, wherein the electrical resistances of the plurality of heating portions are higher than the electrical resistances of the at least one attachment portions.

Example Ex75. An aerosol-generating device according to any of Examples Ex66 to Ex74, wherein the frame comprises an upper surface parallel to the first plane, and at least a first part of the heating element is recessed from the upper surface of the frame by a first distance.

Example Ex76. An aerosol-generating device according to Example Ex75, wherein the first distance is between 0.2 mm and 5 mm.

Example Ex77. An aerosol-generating device according to Example Ex675 or Ex76, wherein an attachment section of each attachment portion is recessed from the upper surface of the frame by the first distance.

Example Ex78. An aerosol-generating device according to any of Examples Ex75 to Ex77, wherein at least a second part of the heating element coincides with a plane formed by the upper surface of the frame.

Example Ex79. An aerosol-generating device according to any of Examples Ex75 to Ex78, wherein the frame comprises a lower surface parallel to the first plane, and at least the first part of the heating element is recessed from the lower surface of the frame by a second distance.

Example Ex80. An aerosol-generating device according to Example Ex79, wherein the second distance is between 0.2 mm and 5 mm.

Example Ex81. An aerosol-generating device according to Example Ex79 or Ex80, wherein an attachment section of the attachment portions is recessed from the lower surface of the frame by the second distance.

Example Ex82. An aerosol-generating device according to any of Examples Ex66 to Ex81, wherein the heating element is serpentine in shape.

Example Ex83. An aerosol-generating device according to any of Examples Ex66 to Ex82, wherein the heater assembly is configured such that when a non-zero voltage is applied across the heating element between the first and second electrical contacts, the temperatures of the plurality of heating portions increase more than the temperatures of the at least one attachment portions.

Example Ex84. An aerosol-generating device according to any of Examples Ex66 to Ex83, wherein the plurality of heating portions and the at least one attachment portion are all integrally formed.

Example Ex85. An aerosol-generating device according to any of Examples Ex66 to Ex84, wherein each attachment portion is directly connected to exactly two heating portions.

Example Ex86. An aerosol-generating device according to any of Examples Ex66 to Ex85, wherein each heating portion is directly connected to exactly two attachment portions, or exactly one attachment portion and either the first electrical contact or the second electrical contact.

Example Ex87. An aerosol-generating device according to any of Examples Ex66 to Ex86, wherein each heating portion has a first width in a first direction, and each attachment portion has a second width in the first direction, and wherein the second width is greater than the first width.

Example Ex88. An aerosol-generating device according to Example Ex87, wherein the ratio of the first width to the second width is between 1/20 and 1/2.

Example Ex89. An aerosol-generating device according to Example Ex88, wherein the ratio of the first width to the second width is between 1/10 and 1/4.

Example Ex90. An aerosol-generating device according to Example Ex87, Ex88 or Ex89, wherein the first width is between 0.1 millimetres and 2 millimetres.

Example Ex91. An aerosol-generating device according to Example Ex90, wherein the first width is between 0.2 millimetres and 1 millimetre.

Example Ex92. An aerosol-generating device according to Example Ex91, wherein the first width is between 0.2 millimetres and 0.5 millimetres.

Example Ex93. An aerosol-generating device according to any of Examples Ex66 to Ex92, wherein the heating element has a thickness in at least one direction perpendicular to the first direction.

Example Ex94. An aerosol-generating device according to Example Ex93, wherein the thickness is between 0.02 millimetres and 0.5 millimetres.

Example Ex95. An aerosol-generating device according to Example Ex94, wherein the thickness is between 0.05 millimetres and 0.3 millimetres.

Example Ex96. An aerosol-generating device according to any of Examples Ex66 to Ex95, wherein the electrical resistance per unit length in the direction of the electrically conductive path of the plurality of heating portions is greater than the electrical resistance per unit length in the direction of the electrically conductive path of the at least one attachment portions.

Example Ex97. An aerosol-generating device according to any of Examples Ex66 to Ex96, wherein the heating element comprises stainless steel.

Example Ex98. An aerosol-generating device according to any of Examples Ex66 to Ex97, wherein the heating element comprises a ferrimagnetic or ferromagnetic material.

Example Ex99. An aerosol-generating device according to any of Examples Ex66 to Ex98, wherein the heating element is coated with a corrosion resistant material.

Example Ex100. An aerosol-generating device according to any of Examples Ex66 to Ex99, wherein the heating element is coated with a ceramic material.

Example Ex101. An aerosol-generating device according to any of Examples Ex66 to Ex100, wherein the total resistance of the heating element is between 0.1 Ohms and 5 Ohms.

Example Ex102. An aerosol-generating device according to Example Ex101, wherein the total resistance of the heating element is between 0.2 Ohms and 1.5 Ohms.

Example Ex103. An aerosol-generating device according to any of Examples Ex66 to Ex102, wherein the heating element and the first and second electrical contacts are integrally formed.

Example Ex104. An aerosol-generating device according to any of Examples Ex66 to Ex103, wherein the heating element and the first and second electrical contacts are formed of the same material.

Example Ex105. An aerosol-generating device according to any of Examples Ex66 to Ex104, wherein the aperture is substantially square or rectangular.

Example Ex106. An aerosol-generating device according to any of Examples Ex66 to Ex104, wherein the aperture is substantially circular.

Example Ex107. An aerosol-generating device according to any of Examples Ex66 to Ex106, wherein the frame is electrically insulating.

Example Ex108. An aerosol-generating device according to Example Ex107, wherein the frame has a thermal conductivity of 1 W/mK or less.

Example Ex109. An aerosol-generating device according to Example Ex107 or Ex108, wherein the frame comprises a heat-resistant polymer.

Example Ex110. An aerosol-generating device according to any of Examples Ex107 to Ex109, wherein the frame comprises polyether ether ketone (PEEK).

Example Ex111. An aerosol-generating device according to Example Ex107 or Ex108, wherein the frame comprises a ceramic.

Example Ex112. An aerosol-generating device according to Example Ex111, wherein the frame comprises alumina.

Example Ex113. An aerosol-generating device according to Example Ex111, wherein the frame comprises zirconia.

Example Ex114. An aerosol-generating device according to any of Examples Ex66 to Ex113, wherein the frame is overmoulded over a section of the heating element.

Example Ex115. An aerosol-generating device according to Example Ex114, wherein the frame is overmoulded over an attachment section of the at least one attachment portions.

Example Ex116. An aerosol-generating device according to Example Ex114 or Ex115, wherein the frame is overmoulded over at least an attachment section of the first electrical contact and at least a section of the second electrical contact.

Example Ex117. An aerosol-generating device according to any of Examples Ex66 to Ex113, wherein the frame comprises an upper element and a lower element.

Example Ex118. An aerosol-generating device according to Example Ex117, wherein the upper element and the lower element comprise press fit elements such that the upper element and the lower elements may be coupled together by press fitting.

Example Ex119. An aerosol-generating device according to Example Ex117, wherein the upper element and the lower element comprise snap fit elements such that the upper element and lower element may be coupled together by snap fitting.

Example Ex120. An aerosol-generating device according to Example Ex118 or Ex119, wherein at least an attachment section of the at least one attachment portions is located between the upper element and the lower element when the upper element and lower element are coupled together.

Example Ex121. An aerosol-generating device according to any of Examples Ex118 to Ex120, wherein at least an attachment section of the first electrical contact and at least a section of the second electrical contact is located between the upper element and the lower element when the upper element and lower element are coupled together.

Example Ex122. An aerosol-generating device according to any of Examples Ex66 to Ex121, wherein the aperture has a cross sectional area between 1 millimetre squared and 1000 millimetres squared in the first plane.

Example Ex123. An aerosol-generating device according to Example Ex122, wherein the aperture has a cross sectional area between 2 millimetres squared and 200 millimetres squared in the first plane.

Example Ex124. An aerosol-generating device according to Example Ex123, wherein the aperture has a cross sectional area between 4 millimetres squared and 50 millimetres squared in the first plane.

Example Ex125. An aerosol-generating device according to any of Examples Ex66 to Ex124, wherein the heating element further comprises at least one heat isolating portion, and wherein each attachment portion is separated from the frame by one heat isolating portion.

Example Ex126. An aerosol-generating device according to Example Ex125, wherein each heating portion is connected to the frame via at least one heat isolating portion.

Example Ex127. An aerosol-generating device according to Example EX125 or Ex126, wherein the plurality of heating portions, the at least one attachment portions, and the at least one heat isolating portion are all integrally formed.

Example Ex128. An aerosol-generating device according to any of Examples Ex125 to Ex127 when dependent on Example Ex87, wherein each heat isolating portion has a third width in the first direction, and wherein the third width is smaller than the second width.

Example Ex129. An aerosol-generating device according to Example Ex128, wherein the ratio of the third width to the second width is between 1/10 and 2/3.

Example Ex130. An aerosol-generating device according to Example Ex129, wherein the ratio of the third width to the second width is between 1/5 and 1/3.

Example Ex131. A heater assembly according any of Examples Ex128 to E130, wherein the third width is approximately equal to the first width.

Example Ex132. An aerosol-generating device according to any of Examples Ex125 to Ex131, wherein the thermal resistance over each attachment portion between adjacent heating portions and adjacent heat isolating portions is lower than the thermal resistance over each heat isolating portion between adjacent attachment portions and the frame.

Example Ex133. An aerosol-generating device according to any of Examples Ex66 to Ex132, further comprising a support structure, wherein the frame at least partially surrounds the support structure, and wherein the support structure comprises a support structure aperture.

Example Ex134. An aerosol-generating device according to Example Ex133, wherein at least a portion of the heating element is within or overlies the support structure aperture.

Example Ex135. An aerosol-generating device according to Example Ex134, wherein the plurality of heating portions is within or overlies the support structure aperture.

Example Ex136. An aerosol-generating system comprising:
a cartridge, the cartridge comprising;
an aerosol-forming substrate in fluid communication with a wicking material,
wherein the wicking material forms part of an external surface of the cartridge, and
an aerosol-generating device, the aerosol-generating device comprising:
a heater assembly, the heater assembly comprising:
   a frame comprising an aperture in a first plane,
   a heating element fixed to the frame,
   a first electrical contact in electrical contact with a first end of the heating element, and
   a second electrical contact in electrical contact with a second end of the heating element, the heating element providing a continuous electrical path between the first electrical contact and the second electrical contact,
   wherein the heating element comprises a plurality of heating portions and at least one attachment portion positioned between heating portions along the continuous electrical path,
   wherein each heating portion is within or overlies the aperture and is separated from the frame by at least one attachment portion, and
   wherein each heating portion comprises a radius of curvature orthogonal to the first plane;
an air flow passage defined between an air inlet and an air outlet, the airflow passage in fluid communication with the heating element,
a power supply, the power supply in electrical contact with the first and second electrical contacts and configured to supply power to the heating element, and
control circuitry, the control circuitry configured to control the supply of power from the power supply to the heating element,
wherein the cartridge is reversibly couplable to the aerosol-generating device, such that when the cartridge is coupled to the device the wicking material is in direct contact with the heating element.

Example Ex137. An aerosol-generating system according to Example Ex136, wherein the airflow passage is in fluid communication with a first side of the heating element, and when the cartridge is coupled to the device the wicking material is in direct contact with a second side of the heating element.

Example Ex138. An aerosol-generating system according to Example Ex136 or Ex137, wherein the cartridge further comprises a cartridge air flow passage defined between an cartridge air inlet and a cartridge air outlet.

Example Ex139. An aerosol-generating system according to Example Ex138, wherein when the cartridge is coupled to the device, the cartridge air inlet is in fluid communication with the air outlet of the device.

Example Ex140. An aerosol-generating system according to Example Ex138 or Ex139, wherein the cartridge air outlet comprises a mouthpiece.

Example Ex141. An aerosol-generating system according to any of Examples Ex136 to E140, wherein the aerosol-forming substrate is a liquid at standard temperature and pressure.

Example Ex142. An aerosol-generating system according to any of Examples Ex136 to Ex141, wherein the heating element comprises a resilient material.

Example Ex143. An aerosol-generating system according to any of Examples Ex136 to Ex142, wherein the cross sectional area of each heating portion perpendicular to the direction of the continuous electrical path is less than the cross sectional area of each attachment portion perpendicular to the direction of the continuous electrical path.

Example Ex144. An aerosol-generating system according to any of Examples Ex136 to Ex143, wherein the electrical resistances of the plurality of heating portions are higher than the electrical resistances of the at least one attachment portions.

Example Ex145. An aerosol-generating system according to any of Examples Ex136 to Ex144, wherein the frame comprises an upper surface parallel to the first plane, and at least a first part of the heating element is recessed from the upper surface of the frame by a first distance.

Example Ex146. An aerosol-generating system according to Example Ex145, wherein the first distance is between 0.2 mm and 5 mm.

Example Ex147. An aerosol-generating system according to Example Ex145 or Ex146, wherein an attachment section of each attachment portion is recessed from the upper surface of the frame by the first distance.

Example Ex148. An aerosol-generating system according to any of Examples Ex145 to Ex147, wherein at least a second part of the heating element coincides with a plane formed by the upper surface of the frame.

Example Ex149. An aerosol-generating system according to any of Examples Ex145 to Ex148, wherein the frame comprises a lower surface parallel to the first plane, and at least the first part of the heating element is recessed from the lower surface of the frame by a second distance.

Example Ex150. An aerosol-generating system according to Example Ex149, wherein the second distance is between 0.2 mm and 5 mm.

Example Ex151. An aerosol-generating system according to Example Ex149 or Ex150, wherein an attachment section of the attachment portions is recessed from the lower surface of the frame by the second distance.

Example Ex152. An aerosol-generating system according to any of Examples Ex136 to Ex151, wherein the heating element is serpentine in shape.

Example Ex153. An aerosol-generating system according to any of Examples Ex136 to Ex152, wherein the heater assembly is configured such that when a non-zero voltage is applied across the heating element between the first and second electrical contacts, the temperatures of the plurality of heating portions increase more than the temperatures of the at least one attachment portions.

Example Ex154. An aerosol-generating system according to any of Examples Ex136 to Ex 153, wherein the plurality of heating portions and the at least one attachment portion are all integrally formed.

Example Ex155. An aerosol-generating system according to any of Examples Ex136 to Ex 154, wherein each attachment portion is directly connected to exactly two heating portions.

Example Ex156. An aerosol-generating system according to any of Examples Ex136 to Ex 155, wherein each heating portion is directly connected to exactly two attachment portions, or exactly one attachment portion and either the first electrical contact or the second electrical contact.

Example Ex157. An aerosol-generating system according to any of Examples Ex136 to Ex 156, wherein each heating portion has a first width in a first direction, and each attachment portion has a second width in the first direction, and wherein the second width is greater than the first width.

Example Ex158. An aerosol-generating system according to Example Ex157, wherein the ratio of the first width to the second width is between 1/20 and 1/2.

Example Ex159. An aerosol-generating system according to Example Ex158, wherein the ratio of the first width to the second width is between 1/10 and 1/4.

Example Ex160. An aerosol-generating system according to Example Ex157, Ex158 or Ex159, wherein the first width is between 0.1 millimetres and 2 millimetres.

Example Ex161. An aerosol-generating system according to Example Ex160, wherein the first width is between 0.2 millimetres and 1 millimetre.

Example Ex162. An aerosol-generating system according to Example Ex161, wherein the first width is between 0.2 millimetres and 0.5 millimetres.

Example Ex163. An aerosol-generating system according to any of Examples Ex136 to Ex 162, wherein the heating element has a thickness in at least one direction perpendicular to the first direction.

Example Ex164. An aerosol-generating system according to Example Ex163, wherein the thickness is between 0.02 millimetres and 0.5 millimetres.

Example Ex165. An aerosol-generating system according to Example Ex164, wherein the thickness is between 0.05 millimetres and 0.3 millimetres.

Example Ex166. An aerosol-generating system according to any of Examples Ex136 to Ex 165, wherein the electrical resistance per unit length in the direction of the electrically conductive path of the plurality of heating portions is greater than the electrical resistance per unit length in the direction of the electrically conductive path of the at least one attachment portions.

Example Ex167. An aerosol-generating system according to any of Examples Ex136 to Ex 166, wherein the heating element comprises stainless steel.

Example Ex168. An aerosol-generating system according to any of Examples Ex136 to Ex 167, wherein the heating element comprises a ferrimagnetic or ferromagnetic material.

Example Ex169. An aerosol-generating system according to any of Examples Ex136 to Ex 168, wherein the heating element is coated with a corrosion resistant material.

Example Ex170. An aerosol-generating system according to any of Examples Ex136 to Ex 169, wherein the heating element is coated with a ceramic material.

Example Ex171. An aerosol-generating system according to any of Examples Ex136 to Ex 170, wherein the total resistance of the heating element is between 0.1 Ohms and 5 Ohms.

Example Ex172. An aerosol-generating system according to Example Ex171, wherein the total resistance of the heating element is between 0.2 Ohms and 1.5 Ohms.

Example Ex173. An aerosol-generating system according to any of Examples Ex136 to Ex 172, wherein the heating element and the first and second electrical contacts are integrally formed.

Example Ex174. An aerosol-generating system according to any of Examples Ex136 to Ex 173, wherein the heating element and the first and second electrical contacts are formed of the same material.

Example Ex175. An aerosol-generating system according to any of Examples Ex136 to Ex 174, wherein the aperture is substantially square or rectangular.

Example Ex176. An aerosol-generating system according to any of Examples Ex136 to Ex 175, wherein the aperture is substantially circular.

Example Ex177. An aerosol-generating system according to any of Examples Ex136 to Ex 176, wherein the frame is electrically insulating.

Example Ex178. An aerosol-generating system according to Example Ex177, wherein the frame has a thermal conductivity of 1 W/mK or less.

Example Ex179. An aerosol-generating system according to Example Ex177 or Ex178, wherein the frame comprises a heat-resistant polymer.

Example Ex180. An aerosol-generating system according to any of Examples Ex177 to Ex179, wherein the frame comprises polyether ether ketone (PEEK).

Example Ex181. An aerosol-generating system according to Example Ex177 or Ex178, wherein the frame comprises a ceramic.

Example Ex182. An aerosol-generating system according to Example Ex181, wherein the frame comprises alumina.

Example Ex183. An aerosol-generating system according to Example Ex181, wherein the frame comprises zirconia.

Example Ex184. An aerosol-generating system according to any of Examples Ex136 to Ex 183, wherein the frame is overmoulded over a section of the heating element.

Example Ex185. An aerosol-generating system according to Example Ex184, wherein the frame is overmoulded over an attachment section of the at least one attachment portions.

Example Ex186. An aerosol-generating system according to any of Examples Ex136 to Ex 185, wherein the frame is overmoulded over at least an attachment section of the first electrical contact and at least a section of the second electrical contact.

Example Ex187. An aerosol-generating system according to any of Examples Ex136 to Ex 183, wherein the frame comprises an upper element and a lower element.

Example Ex188. An aerosol-generating system according to Example Ex187, wherein the upper element and the lower element comprise press fit elements such that the upper element and the lower elements may be coupled together by press fitting.

Example Ex189. An aerosol-generating system according to Example Ex187, wherein the upper element and the lower element comprise snap fit elements such that the upper element and lower element may be coupled together by snap fitting.

Example Ex190. An aerosol-generating system according to Example Ex188 or Ex189, wherein at least an attachment section of the at least one attachment portions is located between the upper element and the lower element when the upper element and lower element are coupled together.

Example Ex191. An aerosol-generating system according to any of Examples Ex188 to Ex190, wherein at least an attachment section of the first electrical contact and at least a section of the second electrical contact is located between the upper element and the lower element when the upper element and lower element are coupled together.

Example Ex192. An aerosol-generating system according to any of Examples Ex136 to Ex 191, wherein the aperture has a cross sectional area between 1 millimetre squared and 1000 millimetres squared in the first plane.

Example Ex193. An aerosol-generating system according to Example Ex192, wherein the aperture has a cross sectional area between 2 millimetres squared and 200 millimetres squared in the first plane.

Example Ex194. An aerosol-generating system according to Example Ex193, wherein the aperture has a cross sectional area between 4 millimetres squared and 50 millimetres squared in the first plane.

Example Ex195. An aerosol-generating system according to any of Examples Ex136 to Ex 194, wherein the heating element further comprises at least one heat isolating portion, and wherein each attachment portion is separated from the frame by one heat isolating portion.

Example Ex196. An aerosol-generating system according to Example Ex195, wherein each heating portion is connected to the frame via at least one heat isolating portion.

Example Ex197. An aerosol-generating system according to Example Ex195 or Ex196, wherein the plurality of heating portions, the at least one attachment portions, and the at least one heat isolating portion are all integrally formed.

Example Ex198. An aerosol-generating system according to any of Examples Ex195 to Ex197 when dependent on Example Ex157, wherein each heat isolating portion has a third width in the first direction, and wherein the third width is smaller than the second width.

Example Ex199. An aerosol-generating system according to Example Ex198, wherein the ratio of the third width to the second width is between 1/10 and 2/3.

Example Ex200. An aerosol-generating system according to Example Ex199, wherein the ratio of the third width to the second width is between 1/5 and 1/3.

Example Ex201. An aerosol-generating system according any of Examples Ex198 to Ex200, wherein the third width is approximately equal to the first width.

Example Ex202. An aerosol-generating system according to any of Examples Ex195 to Ex201, wherein the thermal resistance over each attachment portion between adjacent heating portions and adjacent heat isolating portions is lower than the thermal resistance over each heat isolating portion between adjacent attachment portions and the frame.

Example Ex203. An aerosol-generating system according to any of Examples Ex136 to Ex 202, further comprising a support structure, wherein the frame at least partially surrounds the support structure, and wherein the support structure comprises a support structure aperture.

Example Ex204. An aerosol-generating system according to Example Ex203, wherein at least a portion of the heating element is within or overlies the support structure aperture.

Example Ex205. An aerosol-generating system according to Example Ex204, wherein the plurality of heating portions is within or overlies the support structure aperture.

Example Ex206. A cartridge for an aerosol-generating system, the cartridge comprising:
an aerosol-forming substrate in fluid communication with a wicking material, and
a heater assembly the heater assembly comprising:
   a frame comprising an aperture in a first plane,
   a heating element fixed to the frame, wherein the wicking material is in contact with the heating element,
   a first electrical contact in electrical contact with a first end of the heating element, and
   a second electrical contact in electrical contact with a second end of the heating element, the heating element providing a continuous electrical path between the first electrical contact and the second electrical contact,
   wherein the heating element comprises a plurality of heating portions and at least one attachment portion positioned between heating portions along the continuous electrical path,
   wherein each heating portion is within or overlies the aperture and is separated from the frame by at least one attachment portion, and
   wherein each heating portion comprises a radius of curvature orthogonal to the first plane;

Example Ex207. A cartridge according to Example Ex206, wherein the cartridge is configured to be reversibly couplable to and decouplable from an aerosol-generating device.

Example Ex208. A cartridge according to Example Ex206 or Ex207, further comprising a cartridge air flow passage defined between an cartridge air inlet and a cartridge air outlet.

Example Ex209. A cartridge according to Example Ex208, wherein the cartridge air outlet comprises a mouthpiece.

Example Ex210. A cartridge according to any of Examples Ex206 to Ex209, wherein the aerosol-forming substrate is a liquid at standard temperature and pressure.

Example Ex211. A cartridge according to any of Examples Ex206 to Ex210, wherein the heating element comprises a resilient material.

Example Ex212. A cartridge according to any of Examples Ex206 to Ex211, wherein the cross sectional area of each heating portion perpendicular to the direction of the continuous electrical path is less than the cross sectional area of each attachment portion perpendicular to the direction of the continuous electrical path.

Example Ex213. A cartridge according to any of Examples Ex206 to Ex212, wherein the electrical resistances of the plurality of heating portions are higher than the electrical resistances of the at least one attachment portions.

Example Ex214. A cartridge according to any of Examples Ex206 to Ex213, wherein the frame comprises an upper surface parallel to the first plane, and at least a first part of the heating element is recessed from the upper surface of the frame by a first distance.

Example Ex215. A cartridge according to Example Ex214, wherein the first distance is between 0.2 mm and 5 mm.

Example Ex216. A cartridge according to Example Ex214 or Ex215, wherein an attachment section of each attachment portion is recessed from the upper surface of the frame by the first distance.

Example Ex217. A cartridge according to any of Examples Ex214 to Ex216, wherein at least a second part of the heating element coincides with a plane formed by the upper surface of the frame.

Example Ex218. A cartridge according to any of Examples Ex214 to Ex217, wherein the frame comprises a lower surface parallel to the first plane, and at least the first part of the heating element is recessed from the lower surface of the frame by a second distance.

Example Ex219. A cartridge according to Example Ex218, wherein the second distance is between 0.2 mm and 5 mm.

Example Ex220. A cartridge according to Example Ex218 or Ex219, wherein an attachment section of the attachment portions is recessed from the lower surface of the frame by the second distance.

Example Ex221. A cartridge according to any of Examples Ex206 to Ex220, wherein the heating element is serpentine in shape.

Example Ex222. An cartridge according to any of Examples Ex206 to Ex221, wherein the heater assembly is configured such that when a non-zero voltage is applied across the heating element between the first and second electrical contacts, the temperatures of the plurality of heating portions increase more than the temperatures of the at least one attachment portions.

Example Ex223. A cartridge according to any of Examples Ex206 to Ex222, wherein the plurality of heating portions and the at least one attachment portion are all integrally formed.

Example Ex224. A cartridge according to any of Examples Ex206 to Ex223, wherein each attachment portion is directly connected to exactly two heating portions.

Example Ex225. A cartridge according to any of Examples Ex206 to Ex224, wherein each heating portion is directly connected to exactly two attachment portions, or exactly one attachment portion and either the first electrical contact or the second electrical contact.

Example Ex226. A cartridge according to any of Examples Ex206 to Ex225, wherein each heating portion has a first width in a first direction, and each attachment portion has a second width in the first direction, and wherein the second width is greater than the first width.

Example Ex227. A cartridge according to Example Ex226, wherein the ratio of the first width to the second width is between 1/20 and 1/2.

Example Ex228. A cartridge according to Example Ex227, wherein the ratio of the first width to the second width is between 1/10 and 1/4.

Example Ex229. A cartridge according to Example Ex226, Ex227 or Ex228, wherein the first width is between 0.1 millimetres and 2 millimetres.

Example Ex230. A cartridge according to Example Ex229, wherein the first width is between 0.2 millimetres and 1 millimetre.

Example Ex231. A cartridge according to Example Ex230, wherein the first width is between 0.2 millimetres and 0.5 millimetres.

Example Ex232. A cartridge according to any of Examples Ex206 to Ex231, wherein the heating element has a thickness in at least one direction perpendicular to the first direction.

Example Ex233. A cartridge according to Example Ex232, wherein the thickness is between 0.02 millimetres and 0.5 millimetres.

Example Ex234. A cartridge according to Example Ex233, wherein the thickness is between 0.05 millimetres and 0.3 millimetres.

Example Ex235. A cartridge according to any of Examples Ex206 to Ex234, wherein the electrical resistance per unit length in the direction of the electrically conductive path of the plurality of heating portions is greater than the electrical resistance per unit length in the direction of the electrically conductive path of the at least one attachment portions.

Example Ex236. A cartridge according to any of Examples Ex206 to Ex235, wherein the heating element comprises stainless steel.

Example Ex237. A cartridge according to any of Examples Ex206 to Ex236, wherein the heating element comprises a ferrimagnetic or ferromagnetic material.

Example Ex238. A cartridge according to any of Examples Ex206 to Ex237, wherein the heating element is coated with a corrosion resistant material.

Example Ex239. A cartridge according to any of Examples Ex206 to Ex238, wherein the heating element is coated with a ceramic material.

Example Ex240. A cartridge according to any of Examples Ex206 to Ex239, wherein the total resistance of the heating element is between 0.1 Ohms and 5 Ohms.

Example Ex241. A cartridge according to Example Ex240, wherein the total resistance of the heating element is between 0.2 Ohms and 1.5 Ohms.

Example Ex242. A cartridge according to any of Examples Ex206 to Ex241, wherein the heating element and the first and second electrical contacts are integrally formed.

Example Ex243. A cartridge according to any of Examples Ex206 to Ex242, wherein the heating element and the first and second electrical contacts are formed of the same material.

Example Ex244. A cartridge according to any of Examples Ex206 to Ex243, wherein the aperture is substantially square or rectangular.

Example Ex245. A cartridge according to any of Examples Ex206 to Ex243, wherein the aperture is substantially circular.

Example Ex246. A cartridge according to any of Examples Ex206 to Ex245, wherein the frame is electrically insulating.

Example Ex247. A cartridge according to Example Ex246, wherein the frame has a thermal conductivity of 1 W/mK or less.

Example Ex248. A cartridge according to Example Ex246 or Ex247, wherein the frame comprises a heat-resistant polymer.

Example Ex249. A cartridge according to any of Examples Ex246 to Ex248, wherein the frame comprises polyether ether ketone (PEEK).

Example Ex250. A cartridge according to Example Ex246 or Ex247, wherein the frame comprises a ceramic.

Example Ex251. A cartridge according to Example Ex250, wherein the frame comprises alumina.

Example Ex252. A cartridge according to Example Ex250, wherein the frame comprises zirconia.

Example Ex253. A cartridge according to any of Examples Ex206 to Ex252, wherein the frame is overmoulded over a section of the heating element.

Example Ex254. A cartridge according to Example Ex253, wherein the frame is overmoulded over an attachment section of the at least one attachment portions.

Example Ex255. A cartridge according to any of Examples Ex206 to Ex254, wherein the frame is overmoulded over at least an attachment section of the first electrical contact and at least a section of the second electrical contact.

Example Ex256. A cartridge according to any of Examples Ex206 to Ex252, wherein the frame comprises an upper element and a lower element.

Example Ex257. A cartridge according to Example Ex256, wherein the upper element and the lower element comprise press fit elements such that the upper element and the lower elements may be coupled together by press fitting.

Example Ex258. A cartridge according to Example Ex256, wherein the upper element and the lower element comprise snap fit elements such that the upper element and lower element may be coupled together by snap fitting.

Example Ex259. A cartridge according to Example Ex257 or Ex258, wherein at least an attachment section of the at least one attachment portions is located between the upper element and the lower element when the upper element and lower element are coupled together.

Example Ex260. A cartridge according to any of Examples Ex206 to Ex259, wherein at least an attachment section of the first electrical contact and at least a section of the second electrical contact is located between the upper element and the lower element when the upper element and lower element are coupled together.

Example Ex261. A cartridge according to any of Examples Ex206 to Ex260, wherein the aperture has a cross sectional area between 1 millimetre squared and 1000 millimetres squared in the first plane.

Example Ex262. A cartridge according to Example Ex261, wherein the aperture has a cross sectional area between 2 millimetres squared and 200 millimetres squared in the first plane.

Example Ex263. A cartridge according to Example Ex262, wherein the aperture has a cross sectional area between 4 millimetres squared and 50 millimetres squared in the first plane.

Example Ex264. A cartridge according to any of Examples Ex206 to Ex263, wherein the heating element further comprises at least one heat isolating portion, and wherein each attachment portion is separated from the frame by one heat isolating portion.

Example Ex265. A cartridge according to Example Ex264, wherein each heating portion is connected to the frame via at least one heat isolating portion.

Example Ex266. A cartridge according to Example Ex264 or Ex265, wherein the plurality of heating portions, the at least one attachment portions, and the at least one heat isolating portion are all integrally formed.

Example Ex267. A cartridge according to any of Examples Ex264 to Ex266 when dependent on Example Ex226, wherein each heat isolating portion has a third width in the first direction, and wherein the third width is smaller than the second width.

Example Ex268. A cartridge according to Example Ex267, wherein the ratio of the third width to the second width is between 1/10 and 2/3.

Example Ex269. A cartridge according to Example Ex268, wherein the ratio of the third width to the second width is between 1/5 and 1/3.

Example Ex270. A cartridge according any of Examples Ex267 to Ex269, wherein the third width is approximately equal to the first width.

Example Ex271. A cartridge according to any of Examples Ex264 to Ex270, wherein the thermal resistance over each attachment portion between adjacent heating portions and adjacent heat isolating portions is lower than the thermal resistance over each heat isolating portion between adjacent attachment portions and the frame.

Example Ex272. A cartridge according to any of Examples Ex206 to Ex271, further comprising a support structure, wherein the frame at least partially surrounds the support structure, and wherein the support structure comprises a support structure aperture.

Example Ex273. A cartridge according to Example Ex272, wherein at least a portion of the heating element is within or overlies the support structure aperture.

Example Ex274.
A cartridge according to Example Ex273, wherein the plurality of heating portions is within or overlies the support structure aperture.

Features of one aspect or embodiment of the invention may be applied to the other aspects or embodiments of the invention.

Examples will now be further described with reference to the figures in which:

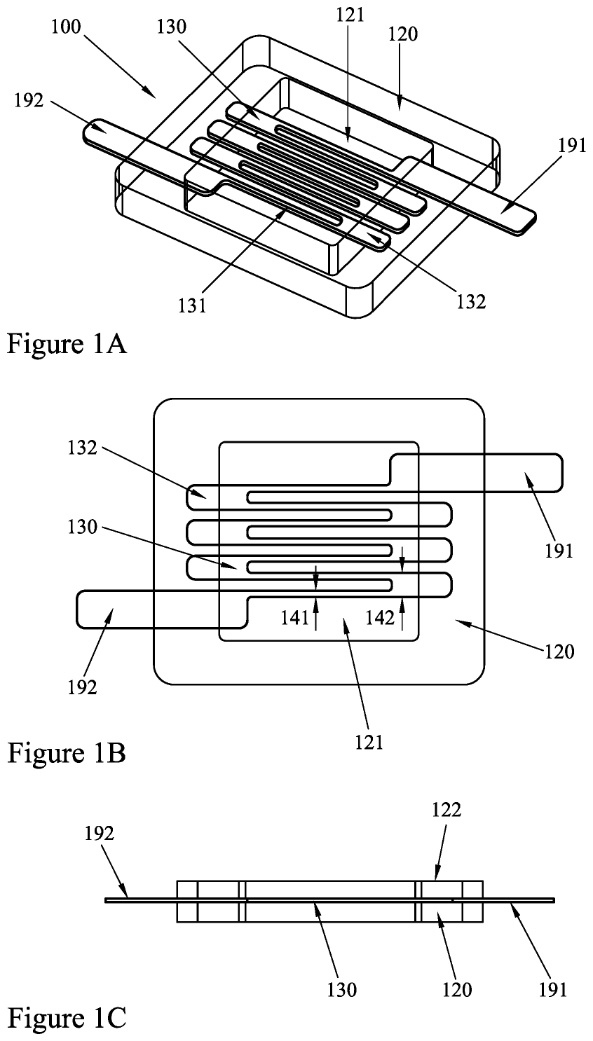

FIG. 1A shows a perspective view of a heater assembly;

FIG. 1B shows a plan view of the heater assembly of FIG. 1A;

FIG. 1C shows a side view of the heater assembly of FIG. 1A;

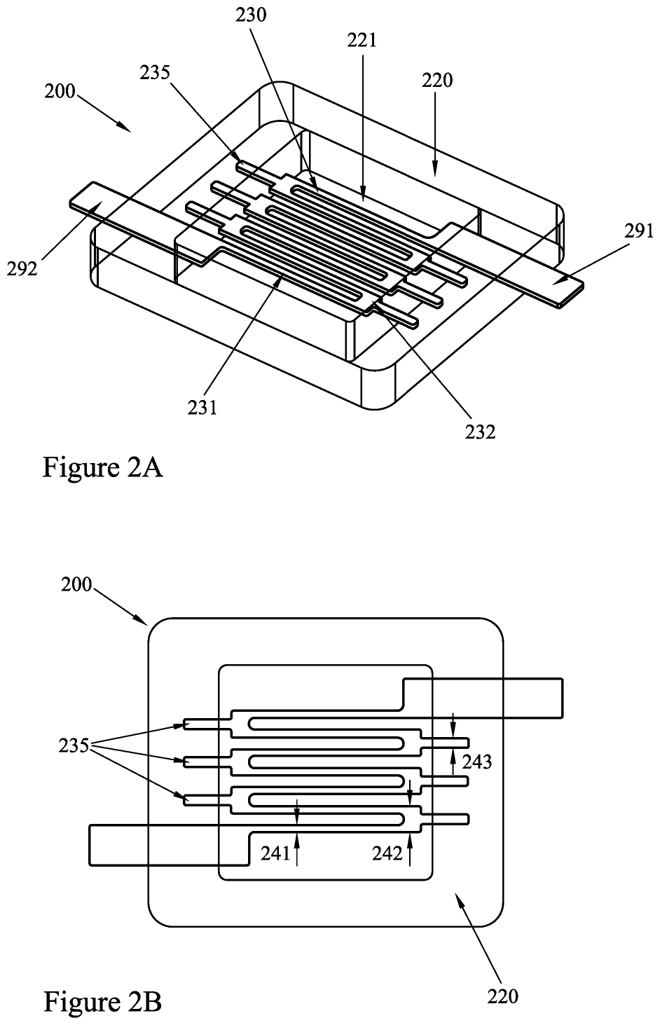

FIG. 2A shows a perspective view of another heater assembly;

FIG. 2B shows a plan view of the heater assembly of FIG. 2A;

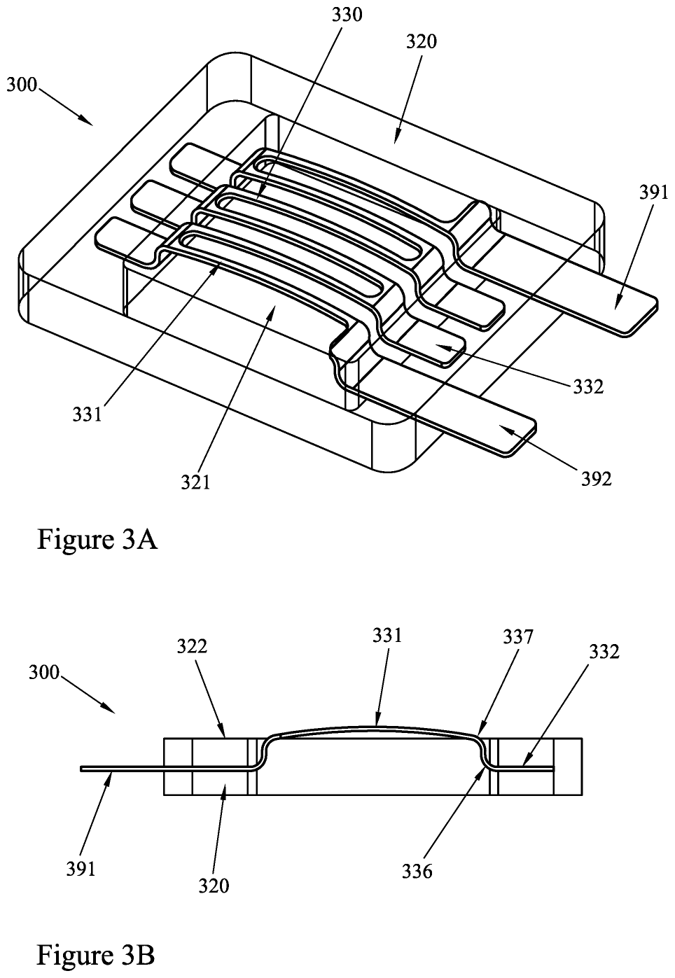

FIG. 3A shows a perspective view of a further heater assembly;

FIG. 3B shows a side view of the heater assembly of FIG. 3A;

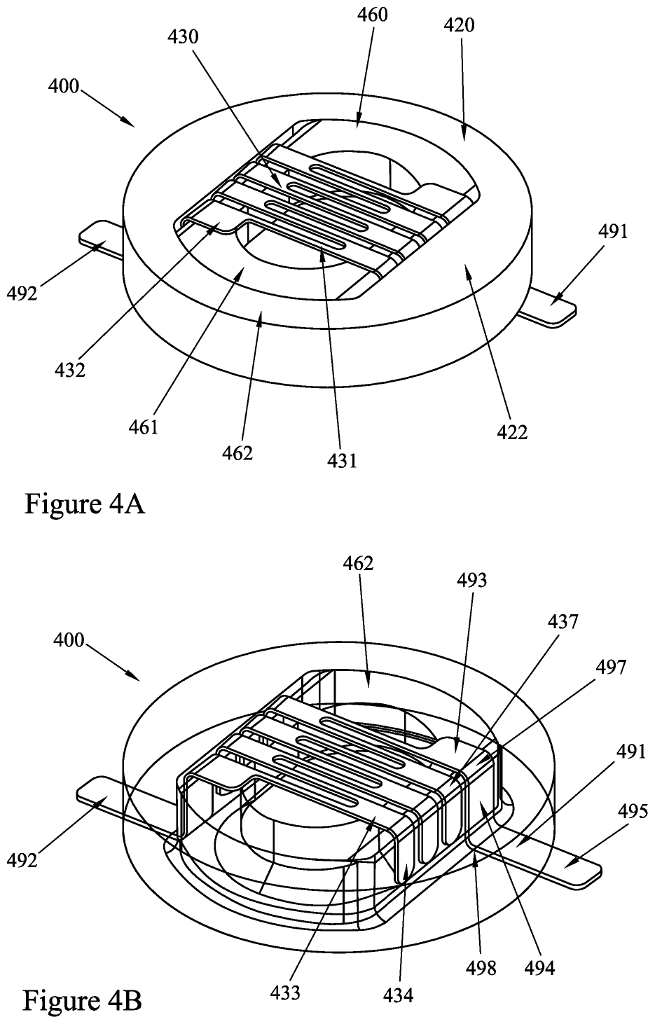

FIG. 4A shows a perspective view of a still further heater assembly;

FIG. 4B shows a perspective view of the heater assembly of FIG. 4A, with selected components of the heater assembly shown as transparent;

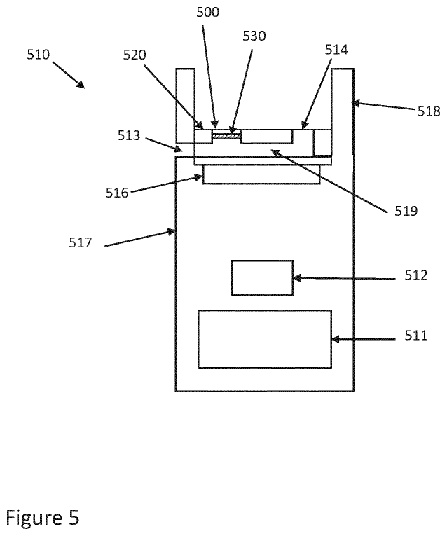

FIG. 5 shows a schematic of a cross-section of an aerosol-generating device, the aerosol-generating device comprising a heater assembly as shown in any of FIGS. 1A to 4B;

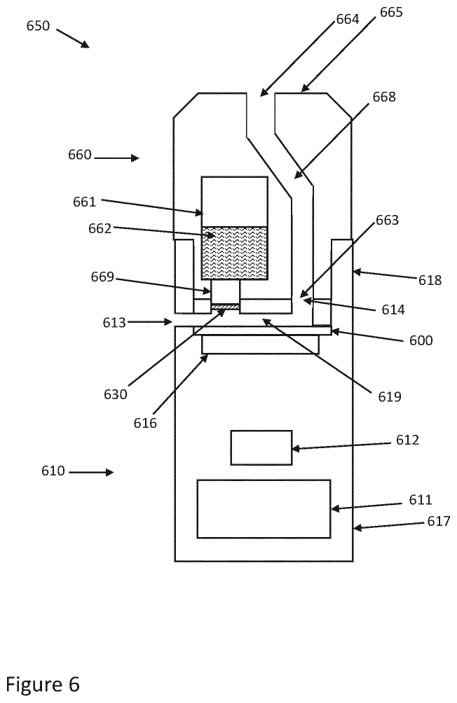

FIG. 6 shows a schematic of a cross-section of an aerosol-generating system, the aerosol-generating system comprising an aerosol-generating device as shown in FIG. 5, and a cartridge coupled to the aerosol-generating device; and

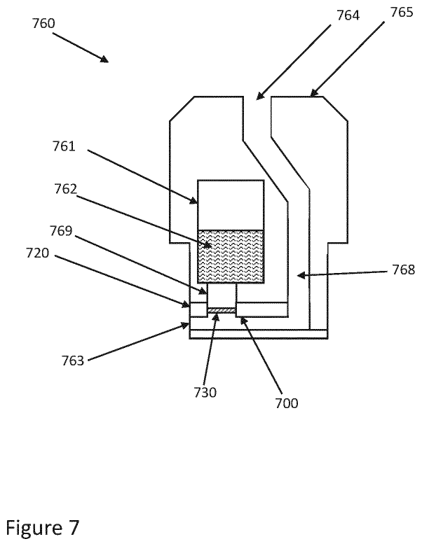

FIG. 7 shows a schematic of a cross-section of a cartridge according to yet another embodiment, the cartridge comprising a heater assembly as shown in any of FIGS. 1A to 4B.

FIG. 1A shows a perspective view of a heater assembly 100. The heater assembly 100 is for an aerosol-generating system, such as an electrically operated smoking system, often referred to as an e-cigarette system. The aerosol-generating system may be a handheld, portable system and has a size comparable to a conventional cigar or cigarette.

The heater assembly 100 comprises a frame 120. The frame 120 has a length and a width in a first plane and a height perpendicular to the first plane, the length and the width being greater than the height. The frame 120 therefore has an upper surface which extends in the first plane. The frame 120 is approximately square shaped in the first plane. The corners of frame 120 in the first plane are radiused. The frame 120 comprises an aperture 121, the aperture 121 located centrally in the frame 120. The aperture 121 passes through the frame perpendicular to the first plane. The aperture 121 is approximately square shaped parallel to the first plane. In this embodiment, the aperture 121 is the same shape as the frame 120, but this may not always be the case. The area of the aperture is 100 millimetres². For example, an approximately squared shape frame may comprise an approximately circular aperture. In the embodiment shown in FIG. 1A, the frame is formed from a heat resistant polymer, such as PEEK, though other suitable materials may be used instead.

The heater assembly 100 further comprises heating element 130. In the embodiment shown in FIG. 1A the heating element 130 is parallel to the first plane. Heating element 130 comprises a plurality of heating portions 131, and at least one attachment portion 132. In the embodiment shown in FIG. 1A, the heating element 130 comprises seven heating portions 131, and six attachment portions 132. In the embodiment shown in FIG. 1A, the plurality of heating portions 131 and at least one attachment portions 132 are integrally formed, and comprise a stainless steel.

The heater assembly 100 further comprises a first electrical contact 191 and a second electrical contact 192. The first electrical contact 191 is attached to a first end of the heating element 130. The second electrical contact 192 is attached to a second end of the heating element 130. The heating element 130 forms a serpentine continuous electrical path between the first electrical contact 191 and the second electrical contact 192. This continuous electrical path has a total electrical resistance of approximately 1 Ohm. A part of the heating element 130 overlies the aperture 121. In particular, each of the heating portions 131 and sections of the attachment portions 132 overlie the aperture 121. A part of the first electrical contact 191 and the second electrical contact 192 protrude out of opposite sides of the frame 120 to allow for electrical connections to external electronics.

The attachment portions 132 are each attached to the frame 120. In particular in this embodiment, the frame 120 is overmoulded over an attachment section of the attachment portions 132. The first electrical contact 191 and the second electrical contact 192 are also attached to the frame 120. In particular in this embodiment, the frame 120 is overmoulded over attachment sections of the first electrical contact 191 and the second electrical contact 192. Overmoulding the frame over attachment sections may however be replaced in alternative embodiments by either snap-fitting, press-fitting or fastening two frame elements together.

The heating element 130 and first and second electrical contacts 191, 192 are integrally formed, and are cut from a flat sheet of metal, for example by laser cutting, waterjet cutting or chemical etching.

In this first embodiment, the heating element 130 is uncoated, however the heating element 130 may be coated by a thin layer of a corrosion resistant material to increase the life span of the heating element 130. An example of such material is a ceramic material.

FIG. 1B shows a plan view of the heater assembly 100 according to the embodiment of FIG. 1A. The heating portions 131 are shown to have a first width 141 in a first direction, and the attachment portions are shown to have a second width 142, also in the first direction. The second width is greater than the first width. The first width is approximately 0.5 millimetres. The second width is approximately 1.5 millimetres. Therefore the ratio of the first width to the second with is approximately 1/3. The serpentine shape of the heating element 130 is more clearly seen in this plan view. The heating portions 131 are shown to have a constant width equal to the first width in the first direction along their entire length. The attachment portions 131 are also shown to have a constant width equal to the second width in the first direction along their entire length.

FIG. 1C shows a side view of the heater assembly 100 according to the embodiment of FIGS. 1A and 1B. The side view is in the first plane. The heating element 130 can be seen to be approximately planar in the first plane, in that the heating element 130 extends much further in the first plane than perpendicular to the first plane. The heating element 130 is shown to have an even thickness perpendicular to the first plane. The thickness of the heating element is approximately 0.1 millimetres. Therefore the heating portions 131 and the attachment portions 132 have an approximately equal thickness perpendicular to the first plane. The heating element 130 is recessed from an upper surface 122 of the frame 120. The heating element 130 is recessed from the upper surface 122 of the frame 120 by approximately 2 millimetres. Similarly, of the first and second electrical contacts 191, 192 are recessed from the upper surface 122 of the frame 120 by approximately 2 millimetres. Similarly, the heating element 130 and the first and second electrical contacts are recessed from a lower surface of the frame 120.

The heater assembly 100 is configured to be coupled to a wicking element, such that the wicking element is in direct contact with one side of the heating element 130. The other side of the heating element 130 may then be exposed to air.

When a current is passed through the heating element 130, or when a non-zero voltage is applied between the first electrical contact 191 and the second electrical contact 192, the heating element 130 heats up as a result of resistive heating. The current passes through the continuous electrical path formed by the heating element 130 in a serpentine direction defined by the shape of the heating element 130. Because the first width is greater than the second width, and the heating portions 131 and the attachment portions 132 have approximately equal thickness perpendicular to the first plane, the cross sectional area of each heating portion 131 perpendicular to the direction of the continuous electrical path is less than the cross sectional area of each attachment portion 132 perpendicular to the direction of the continuous electrical path. Therefore, when a current is passed through heating element 130, or when a non-zero voltage is applied between the first electrical contact 191 and the second electrical contact 192, the temperature of the heating portions 131 will increase more than the temperature of the attachment portions 132.

The effect of the temperature of the heating portions 131 increasing more than the temperature of the attachment portions 132 may be achieved in alternative way. For example, the thicknesses of the heating portions and the attachment portions may be different.

FIG. 2A shows a perspective view of a heater assembly 200 according to another embodiment. The frame 220 and aperture 221 are identical to that shown in FIGS. 1A-1C. The heater assembly 200 comprises a heating element 230, the heating element 230 comprising a plurality of heating portions 231 and at least one attachment portion 232, as in the first embodiment. The heater assembly 200 also comprises a first electrical contact 291 and a second electrical contact 292, as in the first embodiment. Where this embodiment differs from the embodiment of FIG. 1A is that the heating element 230 further comprises at least one heat isolating portion 235. In the embodiment shown in FIG. 2A, The heating element 230 comprises six heat isolating portions 235. The number of heat isolating portions 235 is equal to the number of attachment portions 232. Each one of the heat isolating portions 235 are connected between the frame 220 and one of the attachment portions 232. In particular in the second embodiment, the frame 120 is overmoulded over a section of each of the heat isolating portions 235. Therefore, each attachment portion 232 is separated from the frame by one heat isolating portion 235. In the embodiment shown in FIG. 2A, the plurality of heating portions 231, at least one attachment portions 232 and at least one heat isolating portions 235 are integrally formed, and comprise a stainless steel. The plurality of heating portions 231, at least one attachment portions 232 and at least one heat isolating portions 235 have approximately equal thickness perpendicular to the first plane.

FIG. 2B shows a plan view of a heater assembly of FIG. 2A. As in the embodiment of FIG. 1A, the heating portions 231 are shown to have a first width 241 in a first direction, and the attachment portions are shown to have a second width 242, also in the first direction. The second width is greater than the first width. In this second embodiment, the heat isolating portions 235 have a third width in the first direction. The second width is greater than the third width. The third width is approximately 0.75 millimetres. The ratio of the third width to the second width is therefore approximately 1/2. In the embodiment shown, the third width is greater than the first width, though this may not always be the case. For example, the third width may be approximately equal to the first width, or less than the first width. The thickness of the plurality of heating portions 231, the at least one attachment portions 232 and the at least one heat isolating portions 235 When a current is passed through heating element 230, or when a non-zero voltage is applied between the first electrical contact 291 and the second electrical contact 292, the heating portions 231 and attachment portions 232 heat up as a result of resistive heating. Although the temperature of attachment portions 232 increases less than the temperature of the heating portions 231, as described with respect to FIGS. 1A-1C, the attachment portions 232 may reach a temperature wherein direct contact between attachment portions 232 and the frame 220 is undesirable. Because the third width of heat isolating portions 235 is less than the second width of attachment portions 232, the amount of energy transferred from attachment portions to the frame 220 when a current is passed through the heating element 230 is less than if the attachment portions 232 were instead attached to the frame 220, as in the first embodiment for example.

FIG. 3A shows a perspective view of a heater assembly according to a further embodiment. The frame 320 and aperture 321 are identical to that shown in FIGS. 1A-1C and 2A-2B. The heater assembly 300 comprises a heating element 330, the heating element 330 comprising a plurality of heating portions 331 and at least one attachment portion 332, as in the first and second embodiments. The heater assembly 300 also comprises a first electrical contact 391 and a second electrical contact 392, as in the embodiments of FIGS. 1A-C and FIGS. 2A and 2B. Where this further embodiment differs from the embodiment of FIG. 1A is in the shape of the heating element 330, which can also be seen in FIG. 3B.

FIG. 3B shows a side view of a heater assembly according to the further embodiment. The plurality of heating portions 331 each comprise a radius of curvature orthogonal to the first plane. The outer surface of the curved heating portions 331 is configured to be coupled to a wicking element.

Attachment sections of attachment portions 332, and sections of the first and second electrical contacts 391, 392 are recessed from an upper surface 322 of the frame 320 by approximately 2 millimetres. Similarly, attachment sections of the attachment portions 332, and sections of the first and second electrical contacts 391, 392 are recessed from a lower surface of the frame 320. The attachment portions 332 and the first and second electrical contacts 391, 392 comprise two sets of approximately ninety degree bends. The first set of approximately ninety degree bends 336 orient the attachment portions 332 and the first and second electrical contacts 391, 392 such that they extend perpendicular to the first plane. The second set of approximately ninety degree bends 337 orient the attachment portions 332 and the first and second electrical contacts 391, 392 away from the perpendicular to the first plane. The two sets of approximately ninety degree bends are therefore arranged such that the plurality of heating portions 331 intersect the upper surface 322 of the frame 320, and at least a part of each heating portion 331 extends beyond the plane formed by the upper surface 322 of the frame 320. In this further embodiment, the heating element is bent by cold stamping or micro-bending.

FIG. 4A shows a perspective view of a heater assembly according to a still further embodiment. The heater assembly 400 comprises a heating element 430, the heating element 430 comprising a plurality of heating portions 431 and at least one attachment portion 432, as in the earlier described embodiments. The heater assembly 400 also comprises a first electrical contact 491 and a second electrical contact 492, as in the earlier described embodiments. In contrast to the first embodiment, in this still further embodiment the heater assembly 400 further comprises a support structure 460. The frame 420 surrounds the support structure 460 in the first plane. The support structure 460 can be considered to be located within the aperture of the frame 420. The frame 420 comprises a circular perimeter, and an approximately oval shaped aperture. The support structure 460 comprises an approximately oval shaped perimeter, the perimeter being the same size and shape of the approximately oval shaped aperture of the frame, such that gaps between the frame 420 and the support structure 460 are minimal. The support structure 460 comprises an approximately oval shaped support structure aperture 461 in the first plane. The support structure 460 comprises an upper support structure surface 462 parallel to the first plane, and co-planar with the upper surface 422 of the frame 420. The plurality of heating portions 431 are co-planar with the upper support structure surface 462, and overlie the support structure aperture 461.

FIG. 4B shows a perspective view of a heater assembly of FIG. 4A, with selected components of the heater assembly shown as transparent. In particular, the frame 420 and the support structure 460 are shown as transparent. Each attachment portion 432 comprises a first section 433 and a second section 434. Each first section 433 lies upon the upper support structure surface 462, and so may be considered as co-planar with the upper support structure surface 462. Each attachment portion 432 further comprises a first set of approximately ninety degree bends 437. This first set of ninety degree bends orients each second section 434 such that each second section 434 extends from the upper support structure surface 462 perpendicular to the upper support structure surface 462. Each second section 434 is therefore positioned between the frame 420 and the support structure 460.

Additionally, both of the first and second electrical contacts 491, 492 comprise a first electrical contact section 493, a second electrical contact section 494 and a third electrical contact section 495. In a similar fashion to that of the attachment portions 432, both of the first electrical contact sections 493 are substantially co-planar with the upper support structure surface 462. Both of the first and second electrical contacts 491, 492 further comprise two approximately ninety degree bends 497, 496. The first pair of ninety degree bends 497 orients both second electrical contact sections 494 such that both second electrical contact sections 494 extend from the upper support structure surface 462 perpendicular to the upper support structure surface 462. Both second electrical contact sections 494 are therefore positioned between the frame 420 and the support structure 460. The second pair of ninety degree bends 498 orients the third electrical contact sections 495 such that the third electrical contact sections 495 are co-planar with the lower surface of the frame, and parallel to the first plane. In this embodiment, the heating element is bent by cold stamping or micro-bending.

FIG. 5 shows a schematic of a cross-section of an aerosol-generating device 510, the aerosol-generating device comprising a heater assembly 500 according to any of the previously described embodiments.

The aerosol-generating device 510 is an electrically operated smoking device, often referred to as an e-cigarette system. The aerosol-generating device 510 is a handheld, portable device and has a size comparable to a conventional cigar or cigarette.

The device 510 comprises a battery 511, such as a lithium iron phosphate battery, and a controller 512 electrically connected to the battery 511.

The device 510 comprises an outer casing 517. The outer casing contains the battery 511 and the controller 512. The device 510 is configured to be coupled to a cartridge comprising a wicking element and an aerosol-forming substrate. The device 510 comprises a cartridge coupling portion 518 extending from a proximal end of the device 510. The cartridge coupling portion 518 extends from the outer casing 517 annularly, and provides a cavity into which a cartridge may be accepted.

The heater assembly 500 comprises a fluid permeable heating element 530 and a frame 520, both as described in previous embodiments. First and second electrical contacts (not shown) are electrically connected with the heating element 530, the battery 511 and the controller 512.

The device 510 comprises a device air inlet 513 and a device air outlet 514. The device air inlet 513 is defined in a side wall of the device 610. The device air outlet is defined in a proximal end of the device. The device 510 comprises a device airflow passage 519. The device airflow passage 519 is defined between the device air inlet 513 and the device air outlet 514. The heating element 530 is positioned downstream of the device air inlet 513 and upstream of the device air outlet 514, and is in fluid communication with the device airflow passage 519. In particular, a lower side of the heating element 530 is in fluidic communication with the device airflow passage 519. It can be see that the device airflow passage 519 comprises a heater assembly airflow passage. The heater assembly airflow passage is defined between a heater assembly air inlet and a heater assembly air outlet. In the embodiment shown, the device air outlet 514 comprises the heater assembly air outlet.

The device 510 further comprises a spring element 516. Spring element 516 is fixed relative to the outer casing 517, and is in contact with the heater assembly 500.

FIG. 6 shows a schematic of a cross-section of an aerosol-generating system, the aerosol-generating system comprising an aerosol-generating device as described with reference to FIG. 5 and a cartridge coupled to the aerosol-generating device The cartridge 660 is coupled to the device 610 by the cartridge coupling portion 618. The cartridge 660 comprises a liquid aerosol-forming substrate 662 in a reservoir 661, and a ceramic wicking element 669. In this system, the reservoir 661 is in fluid communication with the ceramic wicking element 669, so that liquid aerosol-forming substrate 662 can flow from the reservoir 661 to the wicking element 669. The wicking element 669 comprises a capillary material having a fibrous or spongy structure. The wicking element 669 also forms part of the external surface of the cartridge 660.

The device air outlet 614 is configured to align with a cartridge air inlet 663 when the device 610 is coupled to the cartridge 660. When the device 610 is coupled to the cartridge 660 the device air flow passage 619 is connected to a cartridge air flow passage 668, defining a system air flow passage from the device air inlet 613 to the cartridge air outlet 664. The cartridge comprises a mouthpiece 665, and the cartridge air outlet 664 is defined in the mouthpiece 665.

The wicking element 669 is configured to align with an aperture of the frame of the heater assembly. In this particular embodiment, when the system comprises a heater assembly according to the first embodiment, the aperture is approximately square shaped with a cross-sectional area of approximately 100 millimetre². The wicking element 669 also has an approximately square cross-section with an approximately identical cross sectional area, so that the wicking element 669 may be easily received by the aperture of the frame of the heater assembly. When the cartridge 660 is coupled to the device 610, a distal end of the wicking element contacts an upper side of the heating element 630.

The device 610 further comprises a spring element 616. Spring element 616 is fixed relative to the device outer casing 617, and is in contact with the heater assembly 600. When a user couples the cartridge 650 to the device 610, the spring element 617 exerts a force of the heater assembly 600. The force exerted onto the heater assembly 600 ensures that good contact is made between the upper side of the heating element 630 and the wicking element 669.

In use, a user puffs on the mouthpiece of the cartridge 665 drawing air into the device air inlet 613. The system 650 is puff actuated meaning that a puff sensor (not shown), which may be a pressure sensor or an air flow sensor, is located in the system 650. In particular, the puff sensor will be located in fluid communication with the system airflow passage, and preferably within or adjacent to the device airflow passage 619. The puff sensor will detect the user puff and send a signal to the controller 612, which results in power being supplied from the battery 611 to the heating element 630 of the heater assembly, via the first and second electrical contacts. This causes a current to flow through the heating element 630, thereby resistively heating the heating element 630. In other examples, the aerosol-generating system 650 may comprise a button that a user presses to send a signal to the controller 612 to supply power from the battery 611 to the heating element 630.

As the heating element 630 is heated, it heats the wicking element 669 and therefore any aerosol-forming substrate 662 contained in the wicking element 669. The heating of the wicking element 669 causes the aerosol-forming substrate 662 to be vaporised.

As the user puffs on the cartridge air outlet 664, air is drawn into the device air inlet 613. The air will pass across the heater assembly as it is drawn through the air passage. The air will flow across a lower side of heating element 630, across the surface of the wicking element 669 and towards the cartridge air outlet 664. The vaporised aerosol-forming substrate 662 is entrained in this flowing air. This entrained vapour then cools and condenses to form an aerosol. The aerosol leaves the device air flow passage 619 through the air outlet 614. Then the aerosol enters the cartridge 660 through the cartridge air inlet 663, exits the cartridge 660 through the cartridge air outlet 664, and is delivered to the user's mouth.

As liquid aerosol-forming substrate 662 in the wicking element 669 is heated, vaporised, and entrained in the air flow, liquid aerosol-forming substrate 662 from the reservoir 661 travels into the wicking element 669. This aerosol-forming substrate 662 from the reservoir 661 effectively replaces the vaporised aerosol-forming substrate 662. Because the wicking element 669 is a capillary material having a fibrous or spongy structure, the liquid aerosol-forming substrate 662 from the reservoir 661 may be drawn into the wicking element 669, at least partly, by capillary action.

After many uses of the aerosol-generating system 650, the wicking element 669 may start to degrade or the reservoir 661 may become empty of aerosol-forming substrate 662. The user can then uncouple the cartridge 660 from the device 610. The cartridge 660 can be removed and disposed of. The aerosol-generating device 610 can then be re-used with a new cartridge.

FIG. 7 shows a schematic of a cross-section of a cartridge 760 according to another embodiment, the cartridge 760 comprising a heater assembly 700 according to any of the embodiments described with reference to FIGS. 1A to 4B.

Similarly to the cartridge 660 shown in FIG. 6, the cartridge 760 shown in FIG. 7 comprises a liquid aerosol-forming substrate 762 in a reservoir 761, and a ceramic wicking element 769. In this system, the reservoir 761 is in fluid communication with the ceramic wicking element 769, so that liquid aerosol-forming substrate 662 can flow from the reservoir 661 to the wicking element 669. The cartridge further comprises a mouthpiece 765, and the cartridge air outlet 764 is defined in the mouthpiece 765.

In contrast to the embodiment shown in FIGS. 5 and 6, the heater assembly 700 is located in the cartridge 760, rather than an aerosol-generating device. The heater assembly 700 is located such that the wicking element 769 is aligned with the aperture of the frame of the heater assembly 700, and such that the distal end of the wicking element 769 contacts the upper side of the heating element 730. Additionally, the cartridge comprises a cartridge air inlet 763 upstream of the heater assembly 700, such that a cartridge air flow path 768 is defined between the cartridge air inlet 763 and the cartridge air outlet 764, and the heating element 730 is in fluid communication with the cartridge air flow path 768.

The cartridge 760 is configured to be coupled to a suitable aerosol-generating device, the device comprising a battery, such as a lithium iron phosphate battery, a controller electrically connected to the battery, first and second device electrical contact portions, and a cartridge coupling portion providing a cavity into which a cartridge 760 may be accepted.

The cartridge 760 comprises first and second cartridge electrical contact portions (not shown), configured to contact first and second device electrical contact portions when the cartridge 760 is coupled to the suitable device, such that power may be supplied from a battery to the heating element 730.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-14. (canceled)

15. A heater assembly for an aerosol-generating device, the heater assembly comprising:
a frame comprising an aperture in a first plane;
a heating element fixed to the frame;
a first electrical contact in electrical contact with a first end of the heating element; and
a second electrical contact in electrical contact with a second end of the heating element, the heating element providing a continuous electrical path between the first electrical contact and the second electrical contact,
wherein the heating element comprises a plurality of heating portions and at least one attachment portion positioned between heating portions along the continuous electrical path,
wherein each heating portion is within or overlies the aperture and is separated from the frame by at least one attachment portion,
wherein each heating portion comprises a radius of curvature orthogonal to the first plane,
wherein the frame further comprises an upper surface parallel to the first plane, and at least a first part of the heating element is recessed from the upper surface of the frame by a first distance, and
wherein at least a second part of the heating element coincides with a plane formed by the upper surface of the frame.

16. The heater assembly according to claim 15, wherein the heating element further comprises a resilient material.

17. The heater assembly according to claim 15, wherein a cross-sectional area of each heating portion perpendicular to a direction of the continuous electrical path is less than a cross-sectional area of each attachment portion perpendicular to the direction of the continuous electrical path.

18. The heater assembly according to claim 15, wherein the plurality of heating portions and the at least one attachment portion are all integrally formed.

19. The heater assembly according to claim 15,
wherein each heating portion has a first width in a first direction perpendicular to a direction of the continuous electrical path when the direction of the continuous electrical path is defined by each heating portion, and each attachment portion has a second width in the first direction, and
wherein the second width is greater than the first width.

20. The heater assembly according to claim 19,
wherein the heating element further comprises at least one heat-isolating portion, and
wherein each attachment portion is separated from the frame by one heat-isolating portion.

21. The heater assembly according to claim 20,
wherein each heat-isolating portion has a third width in the first direction, and
wherein the third width is smaller than the second width.

22. The heater assembly according to claim 15, wherein the frame is overmoulded over a section of the heating element.

23. The heater assembly according to claim 15, wherein the frame further comprises an upper element and a lower element.

24. The heater assembly according to claim 15, wherein the frame is electrically insulating.

25. The heater assembly according to claim 15, wherein the heater assembly is configured such that when a nonzero voltage is applied across the heating element between the first and the second electrical contacts, temperatures of the plurality of heating portions increase more than temperatures of the at least one attachment portions.

26. The heater assembly according to claim 15, wherein the heating element is serpentine in shape.

27. An aerosol-generating device, comprising:
a heater assembly comprising:
a frame comprising an aperture in a first plane,
a heating element fixed to the frame,
a first electrical contact in electrical contact with a first end of the heating element, and
a second electrical contact in electrical contact with a second end of the heating element, the heating element providing a continuous electrical path between the first electrical contact and the second electrical contact,
wherein the heating element comprises a plurality of heating portions and at least one attachment portion positioned between heating portions along the continuous electrical path,
wherein each heating portion is within or overlies the aperture and is separated from the frame by at least one attachment portion,
wherein each heating portion comprises a radius of curvature orthogonal to the first plane, wherein the frame further comprises an upper surface parallel to the first plane, and at least a first part of the heating element is recessed from the upper surface of the frame by a first distance, and
wherein at least a second part of the heating element coincides with a plane formed by the upper surface of the frame;
an air flow passage defined between an air inlet and an air outlet, the air flow passage being in fluid communication with the heating element;
a power supply in electrical contact with the first and the second electrical contacts and being configured to supply power to the heating element; and
control circuitry configured to control a supply of power from the power supply to the heating element.

28. An aerosol-generating system, comprising:
a cartridge comprising:
an aerosol-forming substrate in fluid communication with a wicking material,
wherein the wicking material forms part of an external surface of the cartridge; and
an aerosol-generating device comprising:
a heater assembly comprising:
a frame comprising an aperture in a first plane,
a heating element fixed to the frame,
a first electrical contact in electrical contact with a first end of the heating element, and
a second electrical contact in electrical contact with a second end of the heating element, the heating element providing a continuous electrical path between the first electrical contact and the second electrical contact,
wherein the heating element comprises a plurality of heating portions and at least one attachment portion positioned between heating portions along the continuous electrical path,
wherein each heating portion is within or overlies the aperture and is separated from the frame by at least one attachment portion,
wherein each heating portion comprises a radius of curvature orthogonal to the first plane, wherein the frame comprises an upper surface parallel to the first plane, and at least a first part of the heating element is recessed from the upper surface of the frame by a first distance, and
wherein at least a second part of the heating element coincides with a plane formed by the upper surface of the frame,
an air flow passage defined between an air inlet and an air outlet, the air flow passage being in fluid communication with the heating element,
a power supply in electrical contact with the first and the second electrical contacts and being configured to supply power to the heating element, and
control circuitry configured to control a supply of power from the power supply to the heating element,
wherein the cartridge is reversibly couplable to the aerosol-generating device, such that when the cartridge is coupled to the aerosol-generating device the wicking material is in direct contact with the heating element.
